(19) United States
(12) Patent Application Publication
(10) Pub. No.: US 2004/0072923 A1
(43) Pub. Date: Apr. 15, 2004

(54) Aqueous ink-jet ink

(75) Inventors: Yuki Matsunami, Shizuoka (JP); Shintaro Washizu, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJI PHOTO FILM CO., LTD., Minami-Ashigara-shi (JP)

(21) Appl. No.: 10/652,305

(22) Filed: Sep. 2, 2003

(30) Foreign Application Priority Data
Sep. 2, 2002 (JP) 2002-256995

(51) Int. Cl. C03C 17/00; C09D 5/00

(52) U.S. Cl. 523/160; 523/161

(57) ABSTRACT

An object is to provide an aqueous ink-jet ink which has satisfactory dispersibility into organic and inorganic matrices, excellent dispersibility, storage stability, and can be discharged smoothly, does not invite clogging of discharge heads even after the ink is not used for a long time, and can form images free from bleeding. An aqueous ink-jet ink contains a solvent selected from water, hydrophilic solvents, and mixtures thereof; a binder; a coloring agent; and a surfactant. The ink contains 0.5% by mass or more of a dendritic branching molecule as the binder, and/or a dendritic branching molecule including at least one of metal ions, metal particles, alloy particles, and dyes as the coloring agent.

### BACKGROUND OF THE INVENTION

1. Field of the Invention

The present invention relates to aqueous ink-jet inks in which a coloring agent is satisfactorily dispersed and is stably stored. These inks can be discharged smoothly, do not invite clogging of discharge heads even after they are not used for a long time and can form images free from bleeding.

2. Description of the Related Art

Ink-jet recording processes can use low-cost materials, can make records at a high speed, control noise in recording, can easily make color records and have therefore become widespread. The ink-jet recording processes include, for example, a process in which droplets of an ink are discharged by action of pressure generated by a piezoelectric element, a process in which bubbles are formed in an ink by heat, and droplets of the ink are drawn in and discharged, and a process in which droplets of an ink are drawn in and discharged by electrostatic force. Such ink-jet inks include, for example, water-based inks, oil-based inks, and solid (hot-melt) inks (Japanese Patent Application Laid-Open (JP-A) No. 2000-80314).

Coloring agents for use in the ink-jet inks must be highly soluble in solvents, be capable of making records at a high speed, exhibit good hue, and be satisfactorily dispersed and be stably stored during storage of the resulting inks.

As technology progresses, strong demands have been made on aqueous (water-soluble or water-based) ink-jet inks in which a coloring agent is satisfactorily dispersed, and is stably stored. These inks must be discharged smoothly, must not invite clogging of discharge heads even after they are not used for a long time, and must form images free from bleeding.

### SUMMARY OF THE INVENTION

Accordingly, an object of the present invention is to provide an aqueous ink-jet ink which has excellent dispersibility and storage stability, can be discharged more smoothly, does not invite clogging of discharge heads even after the ink is not used for a long time, and can form images free from bleeding.

An aqueous ink-jet inks according to the present invention contains a solvent selected from the group consisting of water, hydrophilic solvents, and mixtures of these solvents; a binder; a coloring agent; and a surfactant. In a first aspect, the aqueous ink-jet ink contains, in the binder, a branched dendritic molecule in a content of 0.5% by mass or more of the total mass of the ink. In a second aspect, the aqueous ink-jet ink contains, in the binder, a branched dendritic molecule including at least one selected from metal ions, metal particles, alloy particles, and dyes.

In the aqueous ink-jet ink according to the first aspect, the dendritic branching molecule used as the binder has a relatively low molecular weight and resists to tangling of molecular chains. Thus, the ink can be discharged more smoothly, does not invite clogging of discharge heads even after the ink is not used for a long time, and can form high-quality images free from bleeding. In the aqueous ink-jet ink according to the second aspect, the dendritic branching molecule including at least one of metal ions, metal particles, alloy particles, and dyes as the coloring agent can be satisfactorily dispersed into organic and inorganic matrices. The resulting aqueous ink-jet ink is thereby highly uniform.

### DESCRIPTION OF THE PREFERRED EMBODIMENTS

The aqueous (water-soluble or water-based) ink-jet inks of the present invention comprise a solvent selected from water, hydrophilic water, and mixtures of these solvents, a binder, a coloring agent, and a surfactant. They may further comprise other components according to necessity and should be according to the first and/or second aspect.

In the first aspect, the aqueous ink-jet ink comprises 0.5% by mass or more of a dendritic branching molecule (branched dendritic molecule) as the binder. In the second aspect, the aqueous ink-jet ink comprises a dendritic branching molecule including at least one of metal ions, metal particles, alloy particles, and dyes as the coloring agent.

Binders

As the dendritic branching molecule used as the binder, dendrimers, hyperbranched polymers, and dendrons are preferred.

Examples of dendrimers are given by G. R. Newkome, C. N. Moorefield and F. Figtree: “Dendrimers and Dendrons” (2001, published by WILEY-VCH); C. J. Hawker et al: J. Chem. Soc., Commun., p. 1010 (1990); D. A. Tomalia et al: Angew. Chem. Int. Ed. Engl., Vol. 29, p. 138 (1990); C. J. Hawker et al: J. Am. Chem. Soc., Vol. 112, p. 7638 (1990), and J. M. J. Frechet: Science, Vol. 263, p. 1710 (1994).

The dendrimers for use herein are not specifically limited, may be selected according to the purpose, but are preferably those having at least one of a trimethyleneiimine skeleton and an amide-amine skeleton.

The dendrimers are not specifically limited, may be selected according to the purpose, but preferred examples thereof are the following dendrimers (1) to (9) shown below.

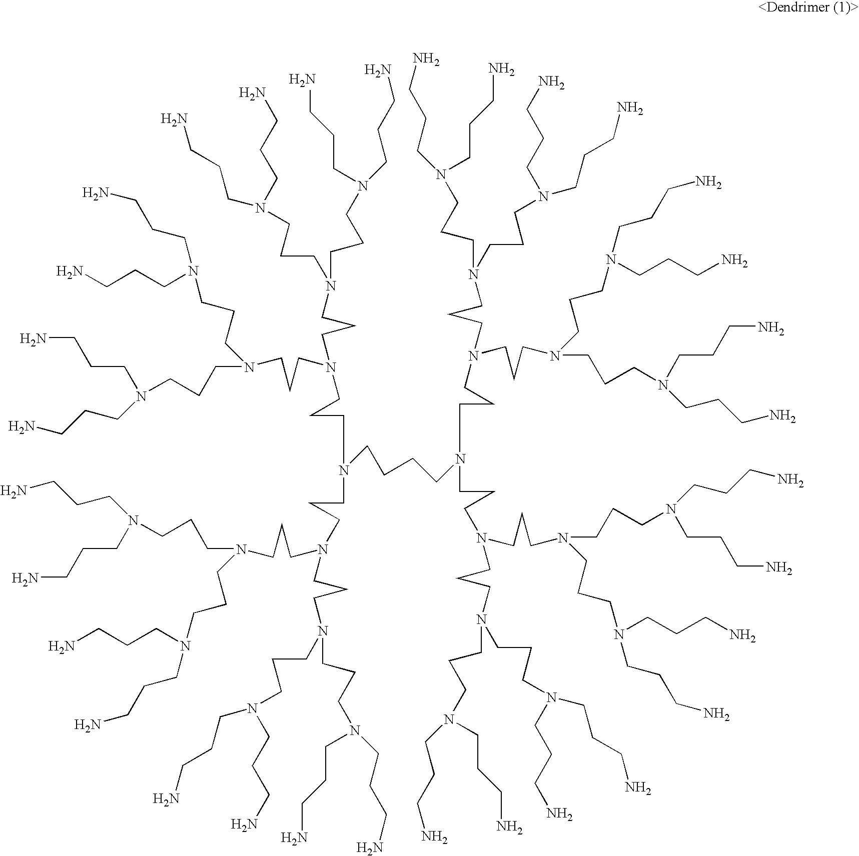

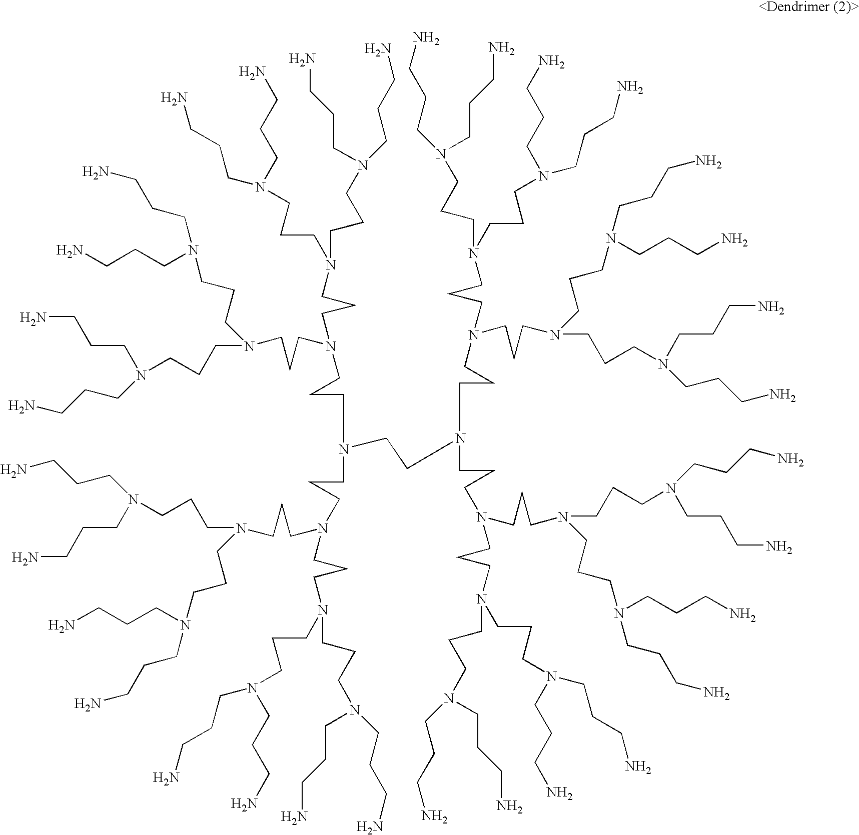

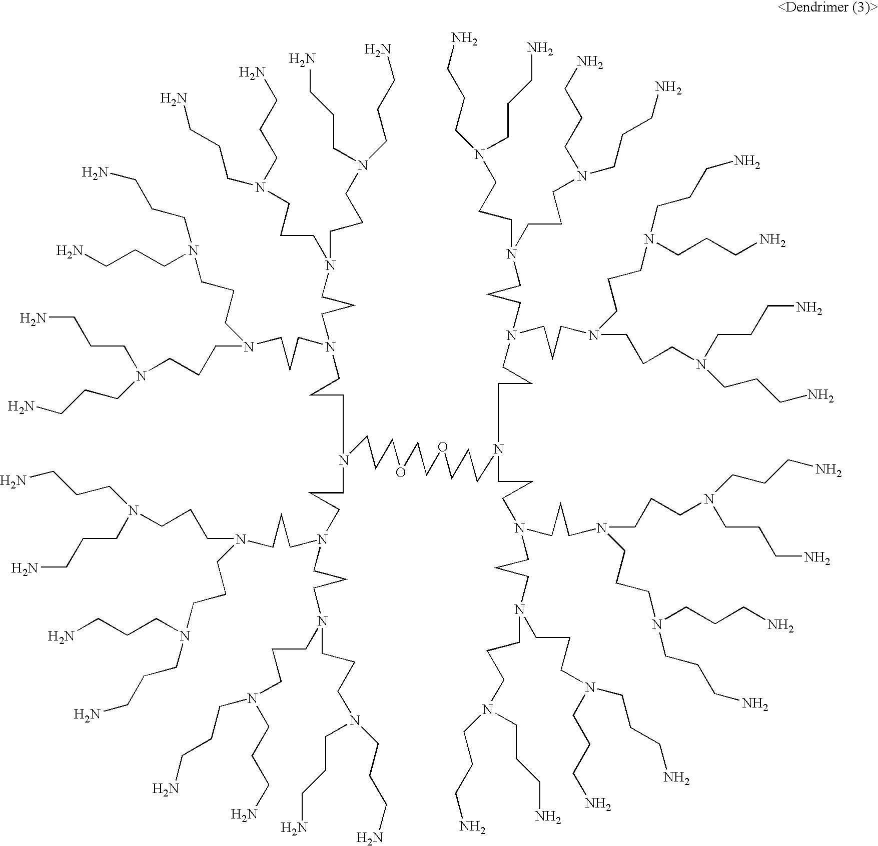

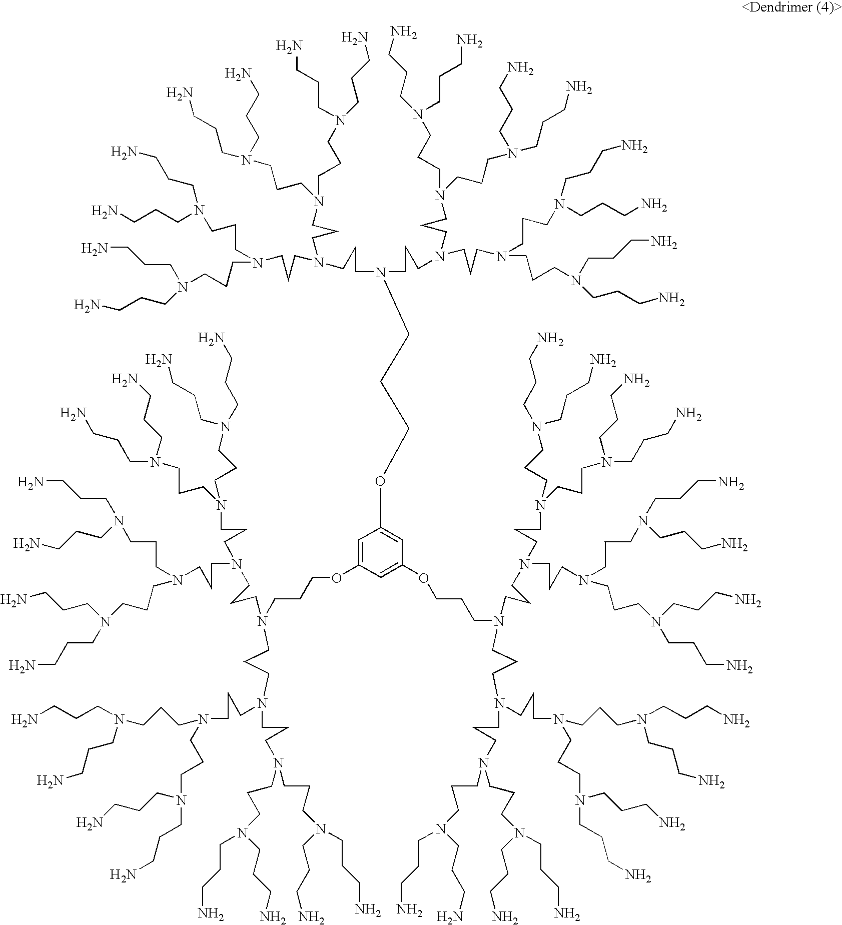

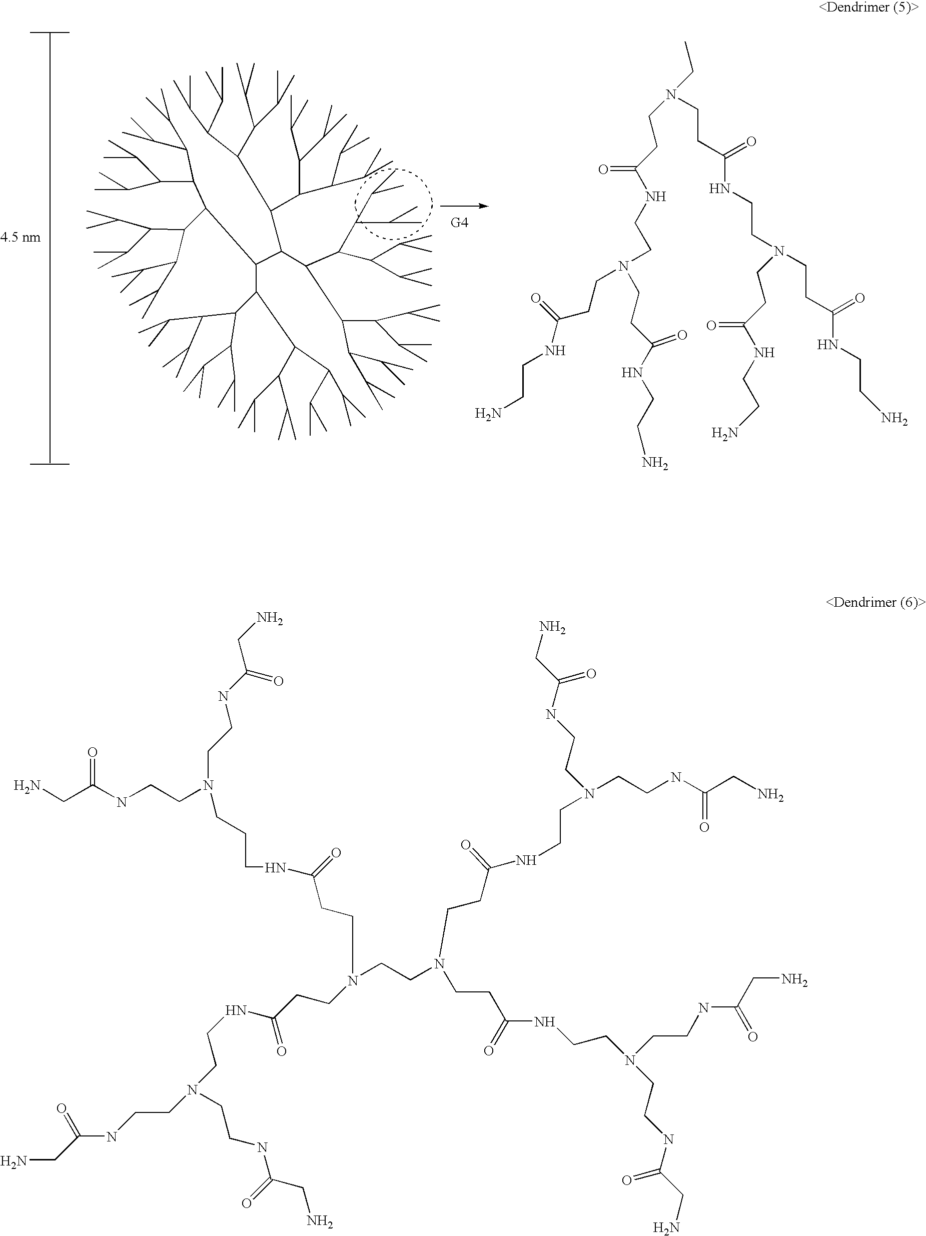

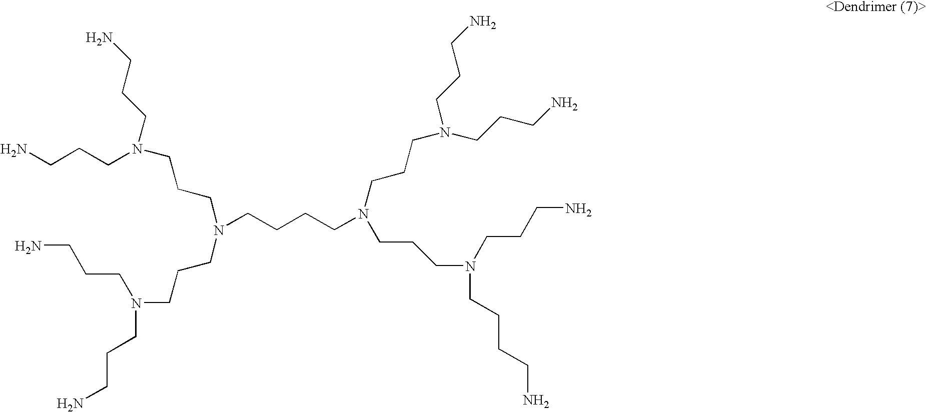

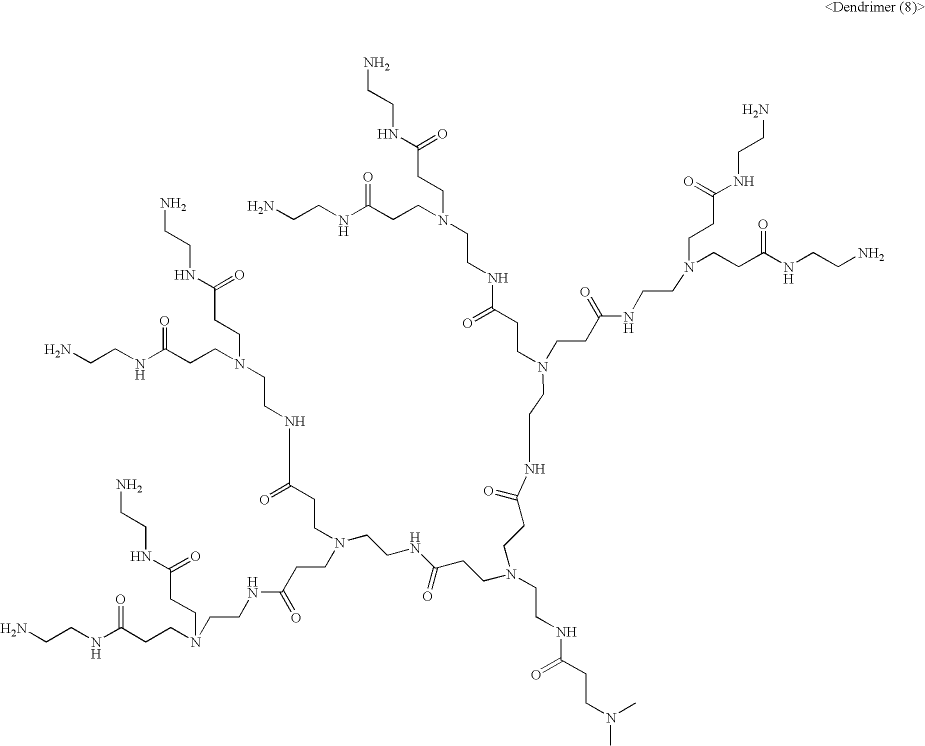

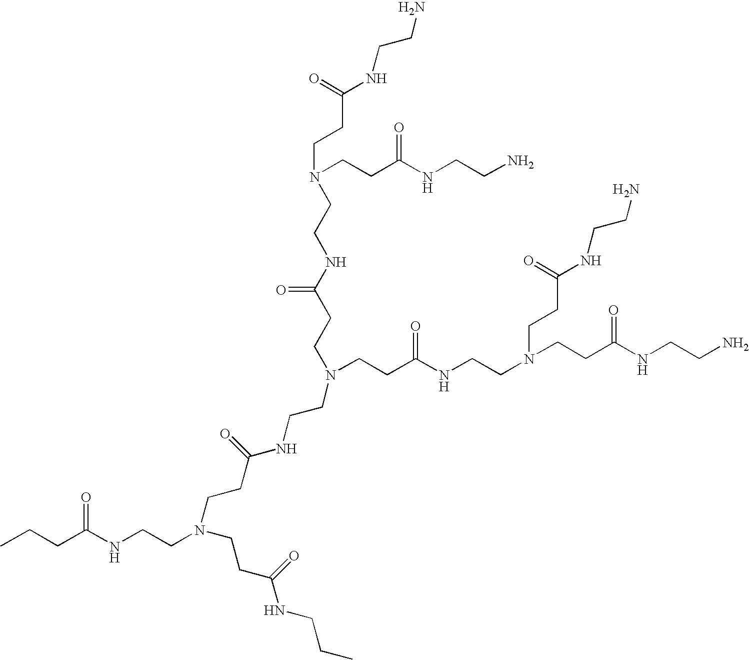

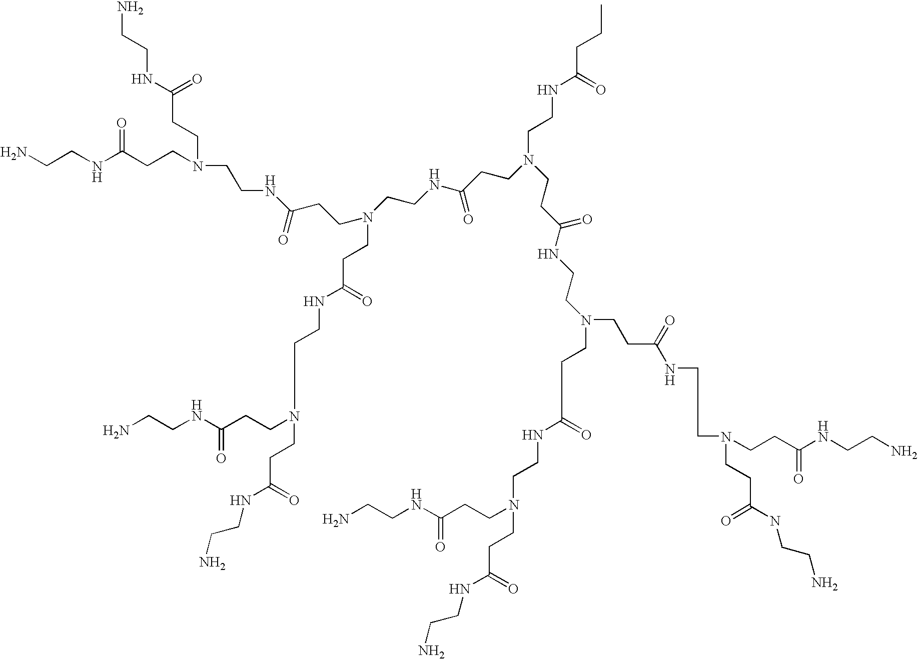

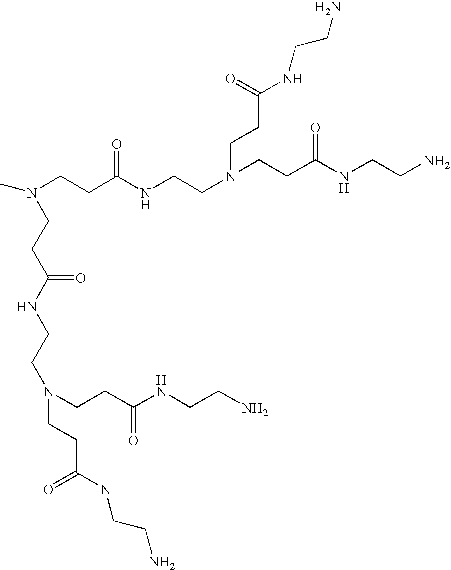

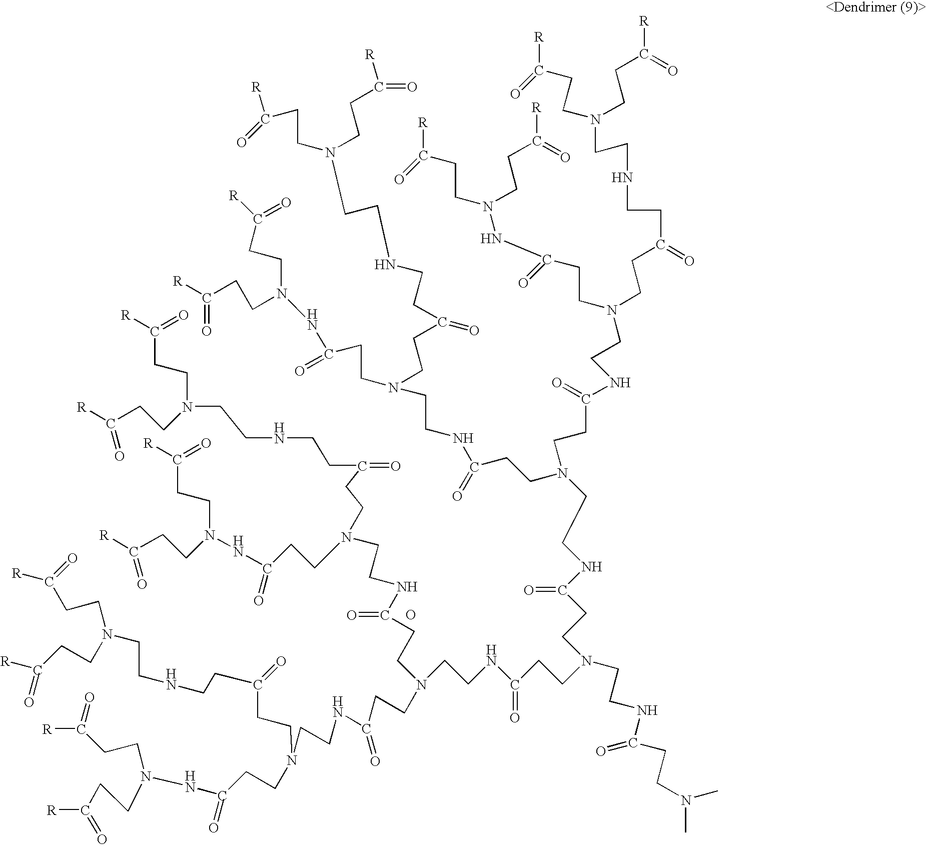

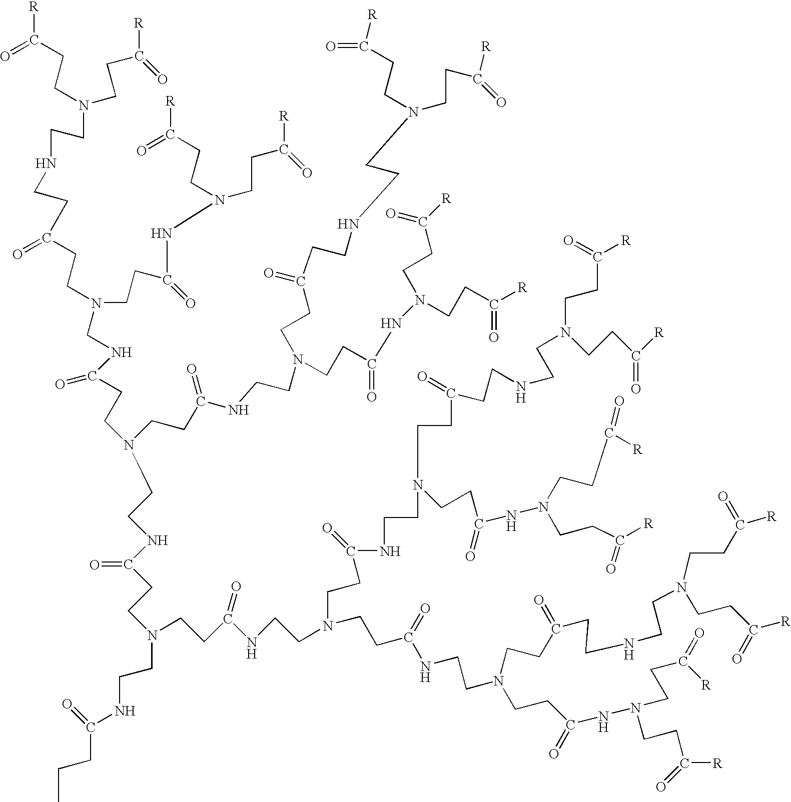

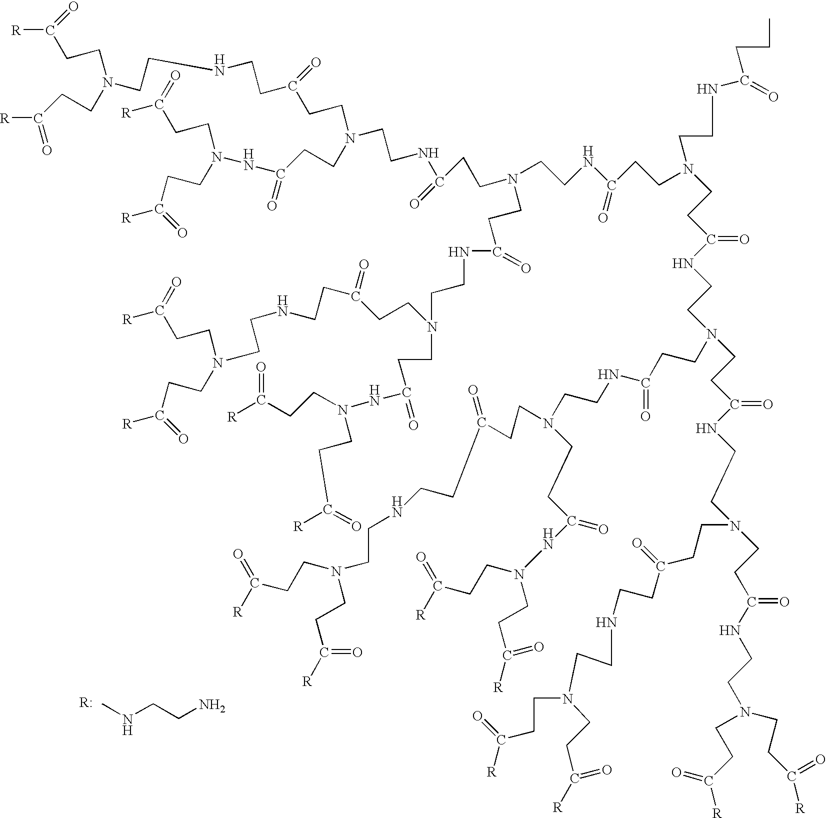

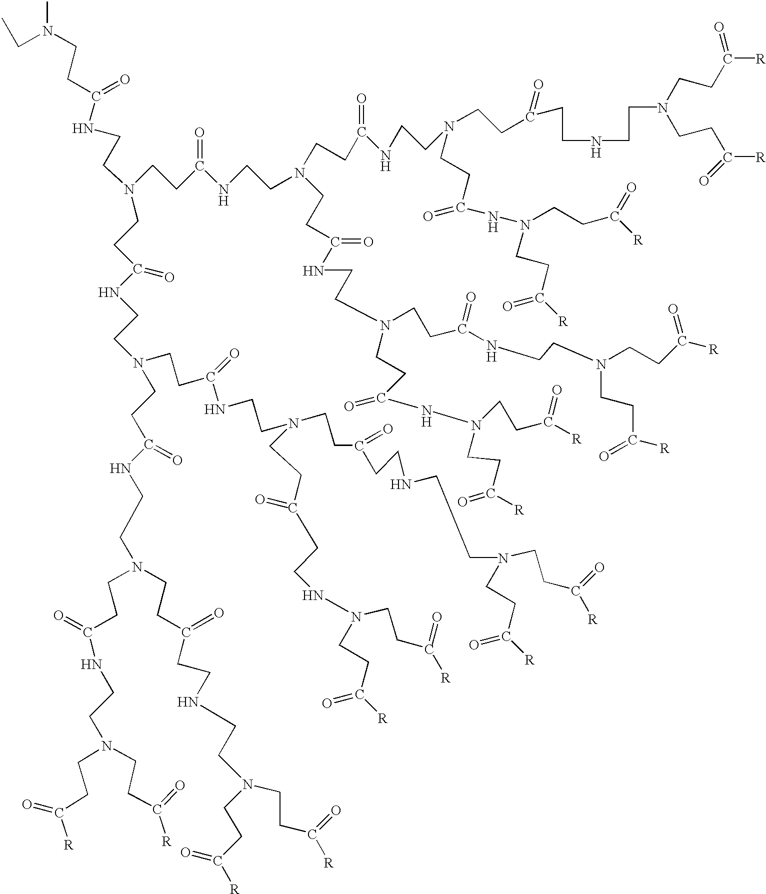

Of these dendrimers, the dendrimer having a trimethyleneimine skeleton can be produced by any method which may be selected according to the purpose, but the following methods may be mentioned.

For example, as disclosed in International Patent (WO-A) No. 93/14147 and International Patent (WO-A) No. 95/02008, in the synthesis, a compound containing ammonia and two or more primary amine groups is taken as starting material, this is reacted with acrylonitrile in a cyanoethylation reaction, the nitrile groups are reduced to primary groups using hydrogen or ammonia (Gl) in the presence of a catalyst, and subsequently, the cyanoethylation and reduction to primary amine groups are repeated three times (G2→G3→G4). Symbols G1, G2, G3, and G4 mean the generations of the dendrimer. The term “generation” as used herein means how-manieth a branch in question is as counted from the core of the molecule.

In this manufacturing method, as starting material, in addition to ammonia, a compound containing at least one type of functional group selected from primary amine, alcohol, phenol, thiol, thiophenol and secondary amine may be used.

For better commercial production, a mordant group in the dendrimer is preferably introduced into the second or higher generation and more preferably introduced into one of the third to tenth generations. In other words, the mordant group preferably modifies the second or higher branches in the molecule, and more preferably modifies one of the third to tenth branches.

There is no particular limitation on the mass average molecular weight of the dendritic branching molecule which may be selected according to the purpose, but 200 to 1,000,000 is preferred, and 500 to 500,000 is more preferred.

There is no particular limitation on the average particle size of the dendritic branching molecule which may be selected according to the purpose, but for example 1 nm to 100 nm is preferred, and 1 nm to 50 nm is more preferred.

Examples of the hyperbranched polymers can be found in those mentioned by Koji Ishizu et al. in “Nanotechnology for Branched Polymers” (Industrial Publishing & Consulting, Inc., Tokyo Japan (2000)).

The hyperbranched polymers for use in the present invention are not specifically limited, may be selected according to the purpose, but are preferably the following hyperbranched polymers (1) and (2) shown below.

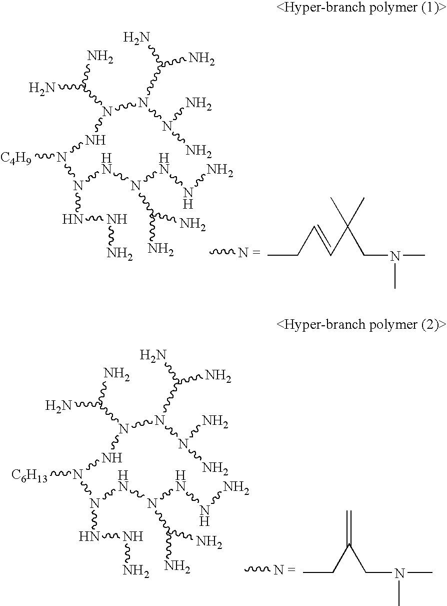

The method of manufacturing the aforesaid hyperbranched polymer may for example be synthesis by a ring-opening polymerization of a cyclic compound taking a primary amine as a nucleophilic component and using a palladium catalyst, as described in M. Suzuki et al: Macromolecules, Vol. 25, p. 7071 (1992) and Vol. 31, p. 1716 (1998).

The content of the dendritic branching molecule as the binder must be 0.5% by mass or more, is preferably from 0.5% to 30% by mass, and more preferably from 0.5% to 20% by mass, of the total solids content of the aqueous ink-jet ink. If the content is less than 0.5% by mass, the ink may not be discharged smoothly, thus inviting clogging of heads when the ink is not used for a long time or inviting bleeding in recorded images.

The aqueous ink-jet ink may further comprise any of conventional binders for ink-jet inks as the binder, in addition to the dendritic branching molecule. Such binders may be appropriately selected according to the purpose.

Coloring Agents

The aqueous ink-jet ink according to the second aspect comprises, as a coloring agent, a dendritic branching molecule including at least one of metal ions, metal particles, alloy particles (hereinafter these metal particles and alloy particles are generically referred to as “metallic particles”), and dyes.

The dendritic branching molecule including at least one of the metallic particles and dyes means a dendritic branching molecule having a multi-branch structure with a constant number of coordination sites and is preferably a monodispersed dendritic branching molecule. Such dendritic branching molecules include dendrons as well as dendrimers having branches sequentially branch off from a core as the center of the branched structure. They also include dendritic branching molecules partially having such a branched dendritic structure. Namely, they may be substances comprising a dendritic branching molecule and a polymer or another material combined with a functional group on the surface of the dendritic branching molecule or may be organic molecules structurally partially having a dendritic branching molecule. For example, the dendritic branching molecules for use in the present invention include molecules each comprising a dendrimer whose surface is combined with a principal chain of a polymer or molecules each having a dendron whose surface is combined with a principal chain of a polymer.

When the dendritic branching molecule has S atoms, N atoms, or other sites capable of coordinating with a metal ion, the number of the sites is substantially uniform. When a metal ion solution is added thereto, metal ions coordinate with the coordinating sites. For example, even when the solution contains excess amounts of metal ions, only an equivalent amount of metal ions can coordinate with one coordinating site. Namely, the amount of the coordinated metal ions is determined depending on the number of coordinating sites in the dendritic branching molecule. After coordination, excess metal ions are removed, and particles are formed via reduction or a reaction with a specific reagent. The size of the particles depends on the amount of the coordinated metal ions. Accordingly, the particles prepared from such a dendritic branching molecule have a constant size.

The metal herein can be incorporated into a dendritic branching molecule by a method using electrostatic interaction.

The dendritic branching molecules for use herein are not specifically limited, may be selected according to the purpose and include, for example, dendritic branching polymers and dendrons.

Examples of dendritic branching polymers are hyperbranched polymers and dendrimers which branch off in an orderly manner from a core located at the center of the branches.

Dendrons are structures having regularly ordered branches and substituents without branches in the core.

There is no particular limitation on the dendrimers and the number of generations of dendrons, but 1 to 6 generations are usually preferred from the viewpoint of synthesis, and 1 to 4 generations are more preferred.

The dendrimers are not specifically limited, may be selected according to the purpose, but preferred examples thereof are the following dendrimers (1) to (5) shown below.

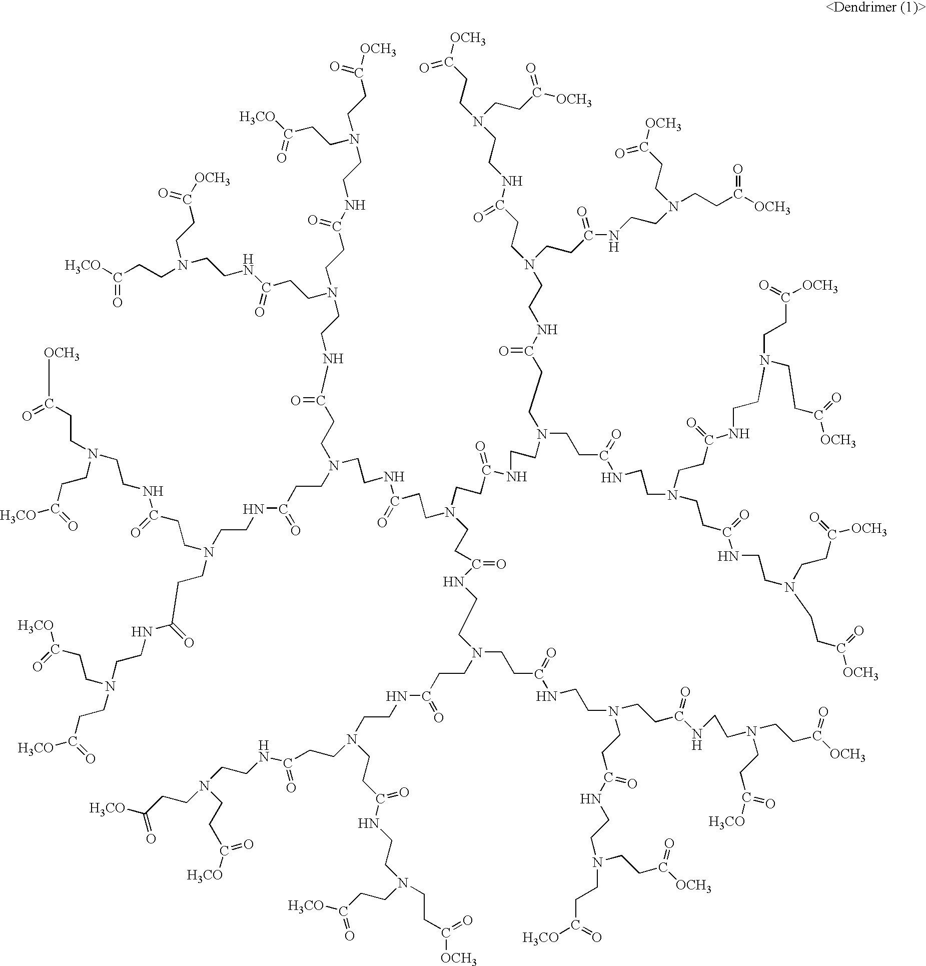

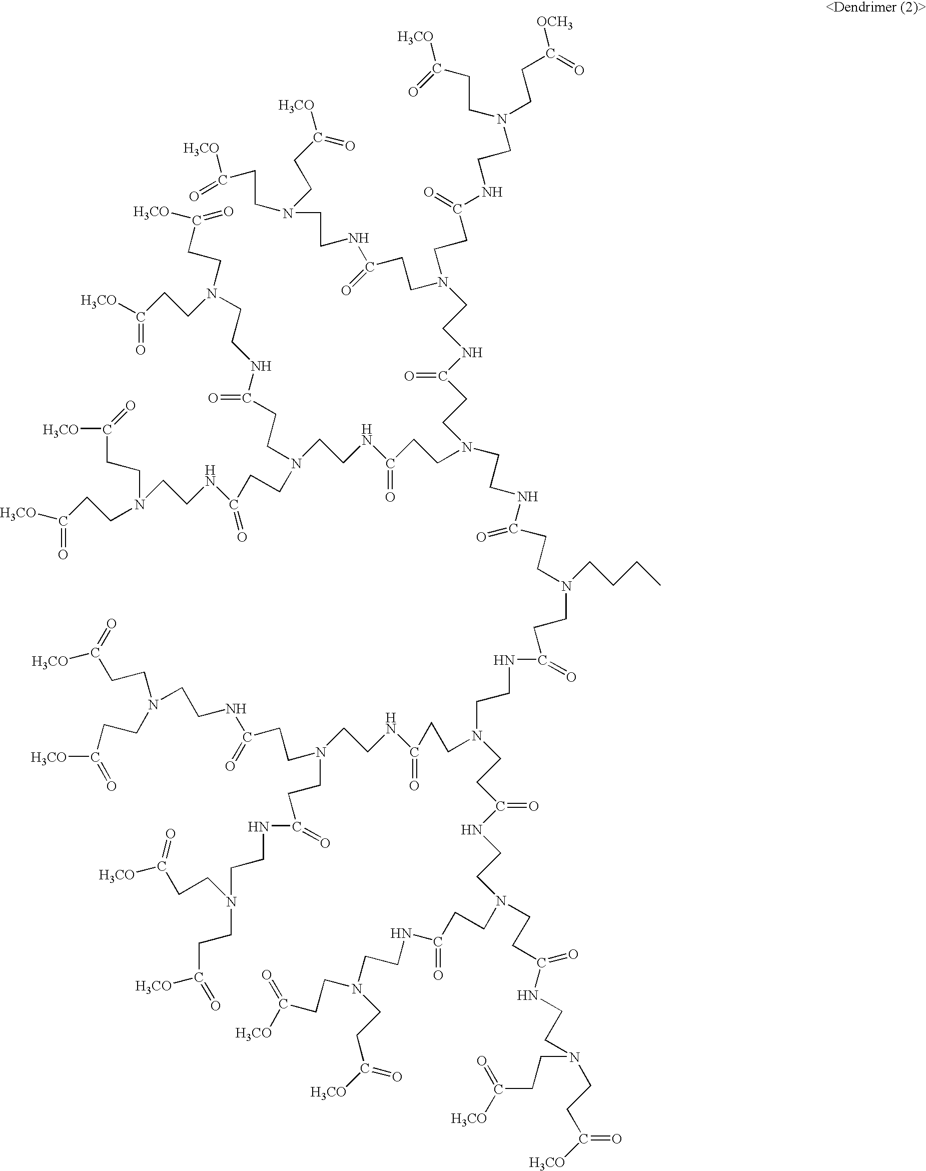

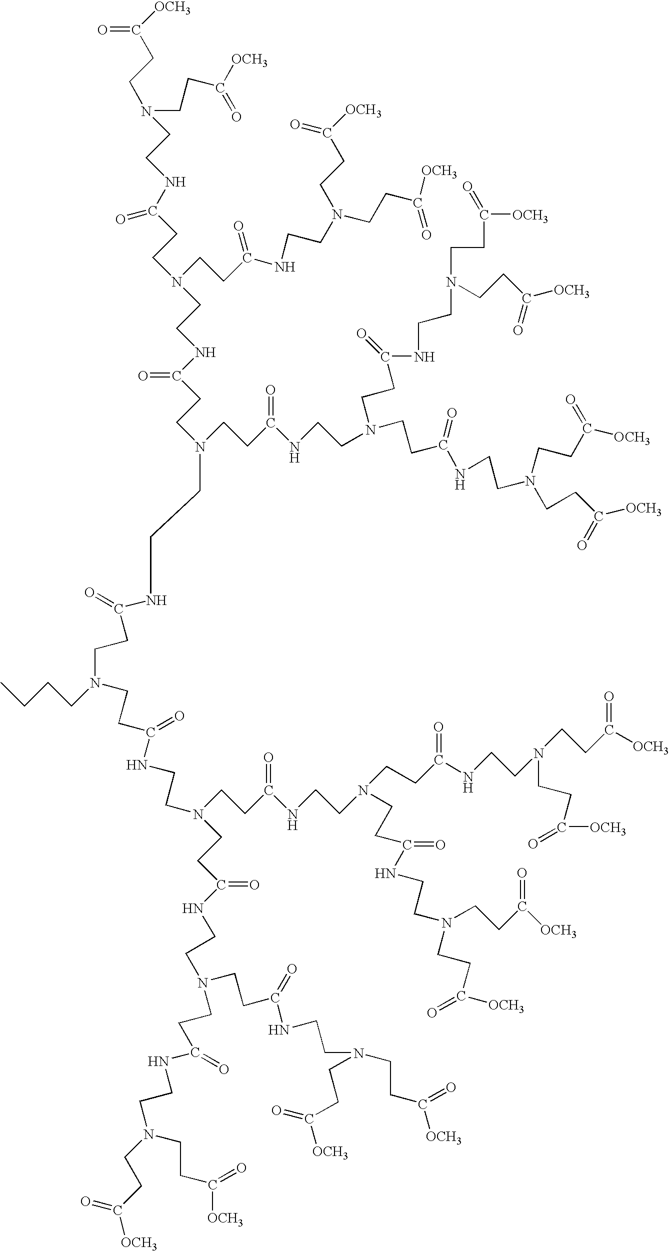

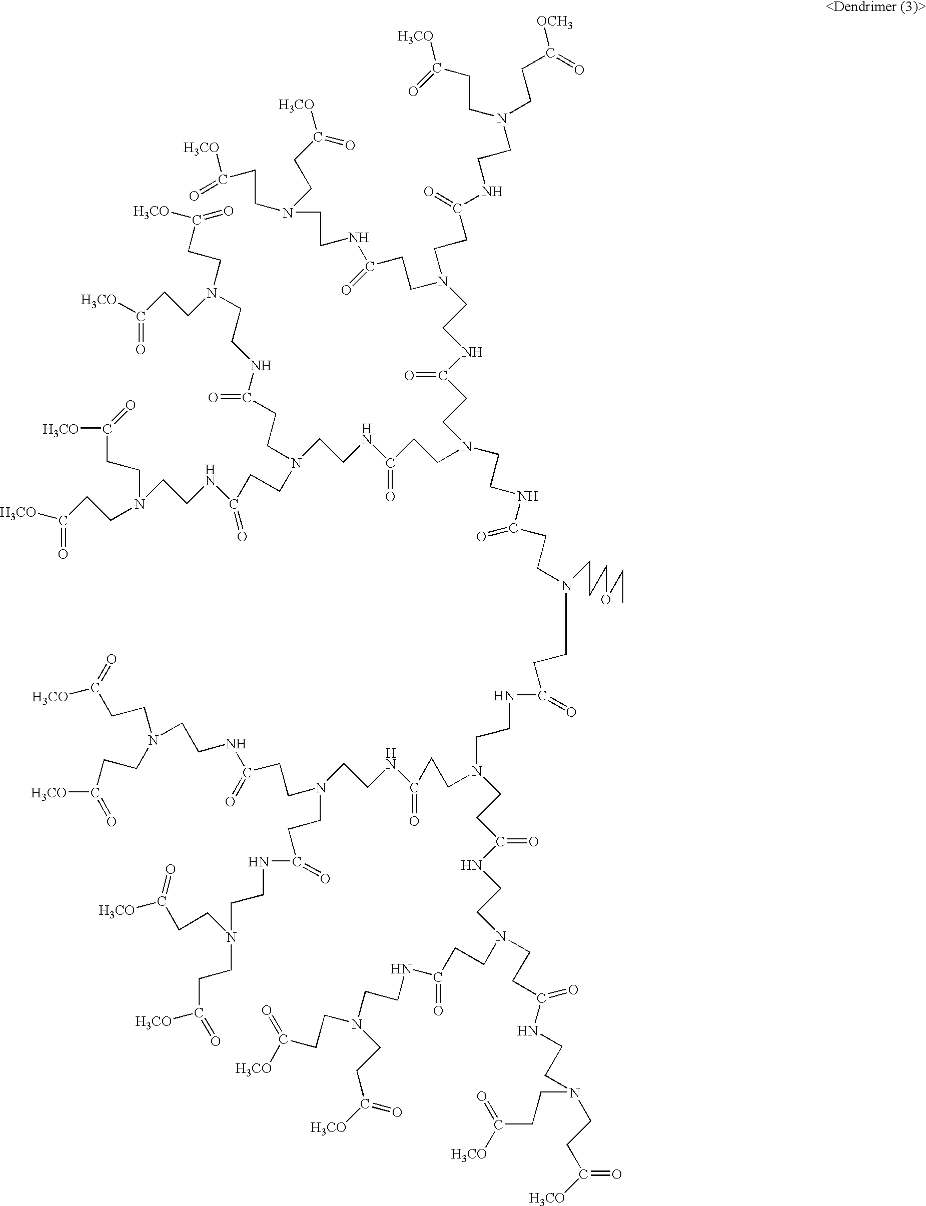

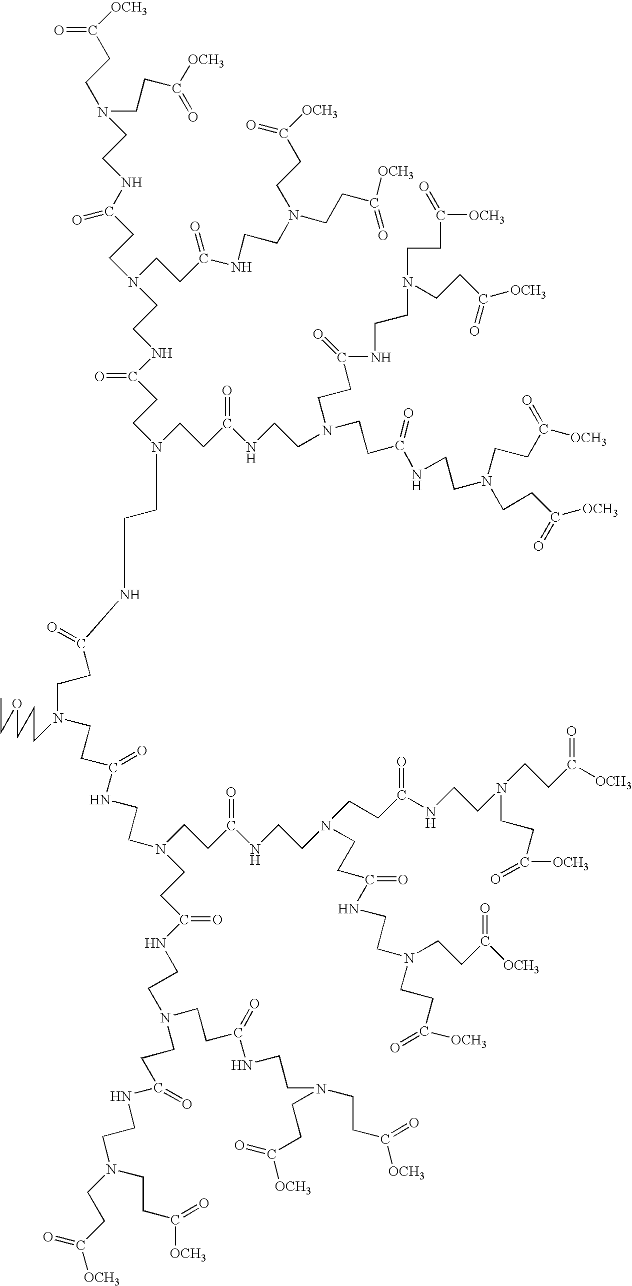

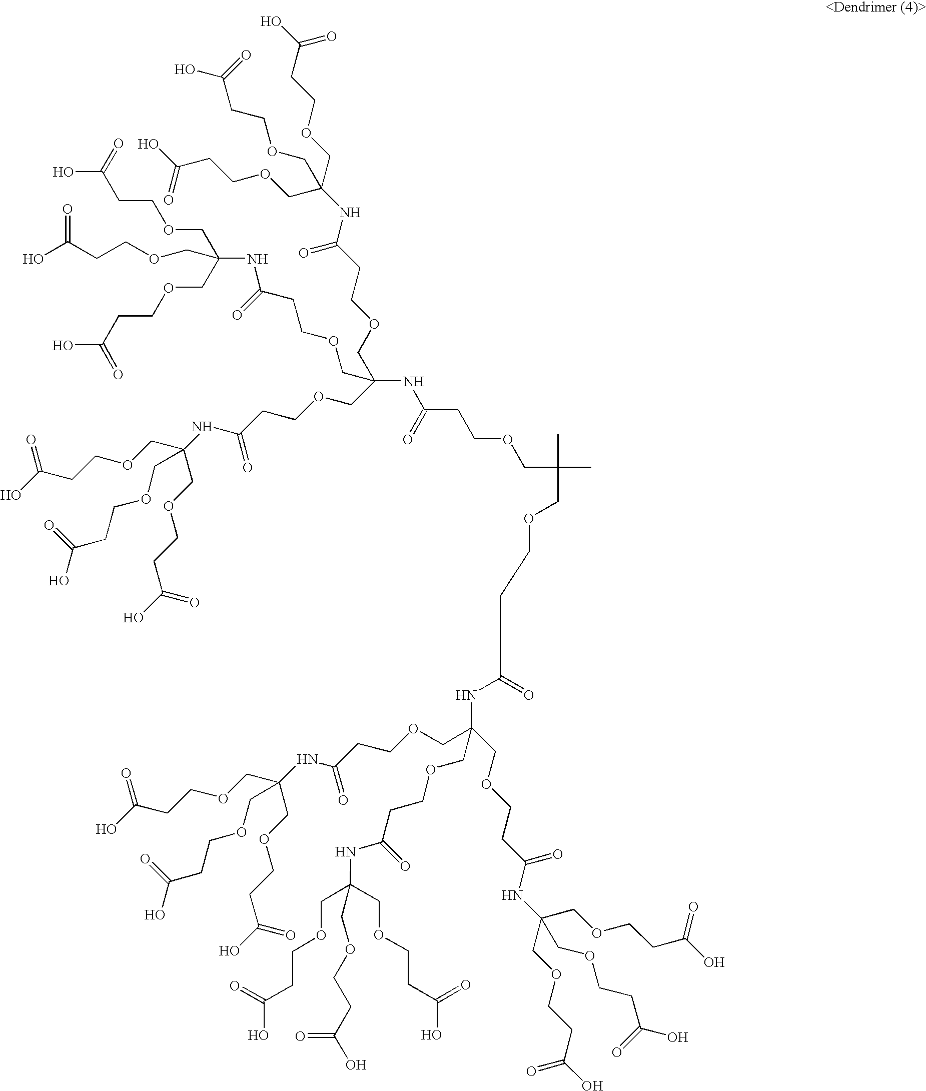

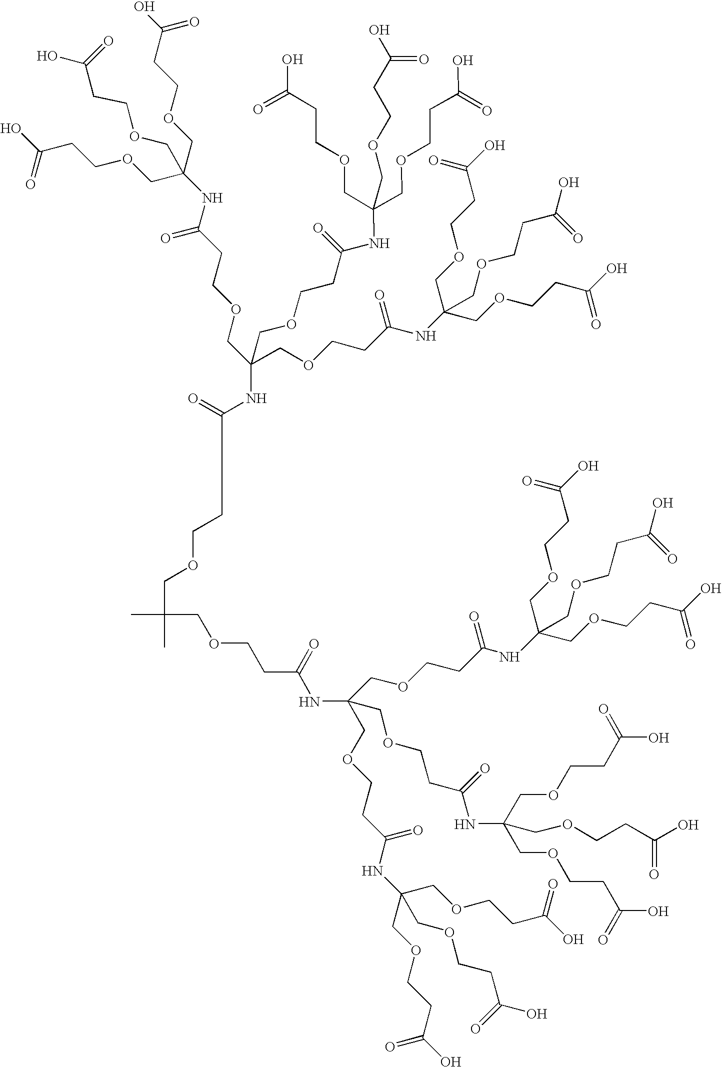

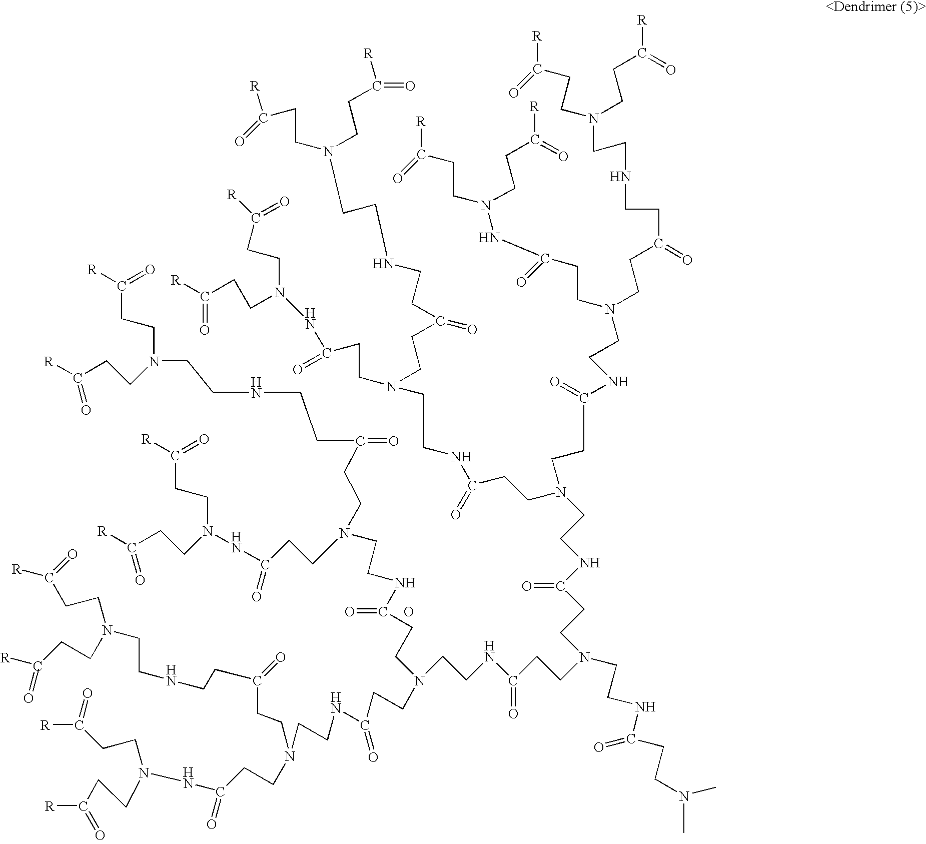

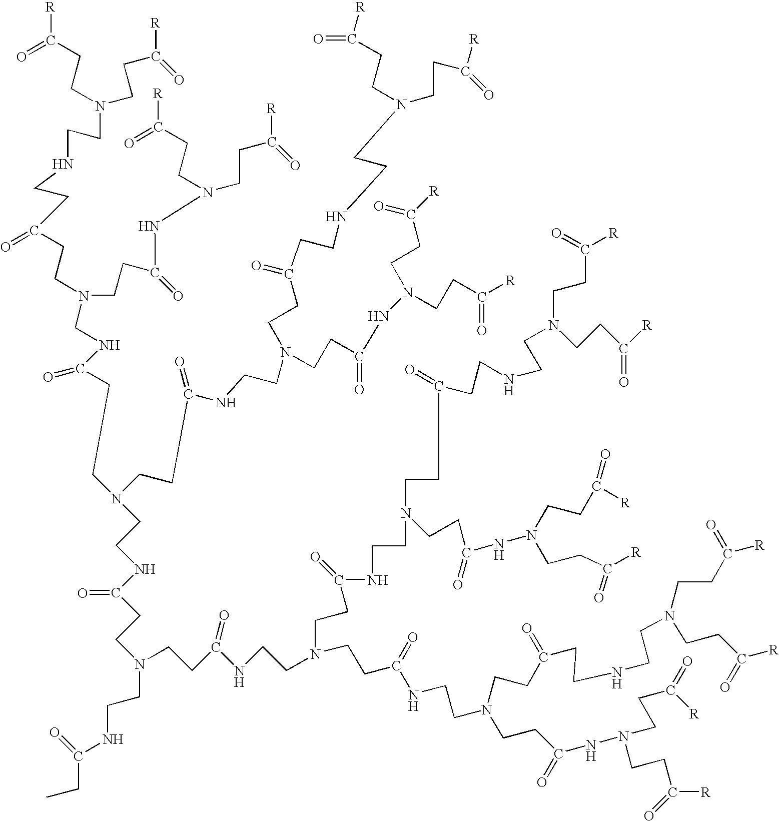

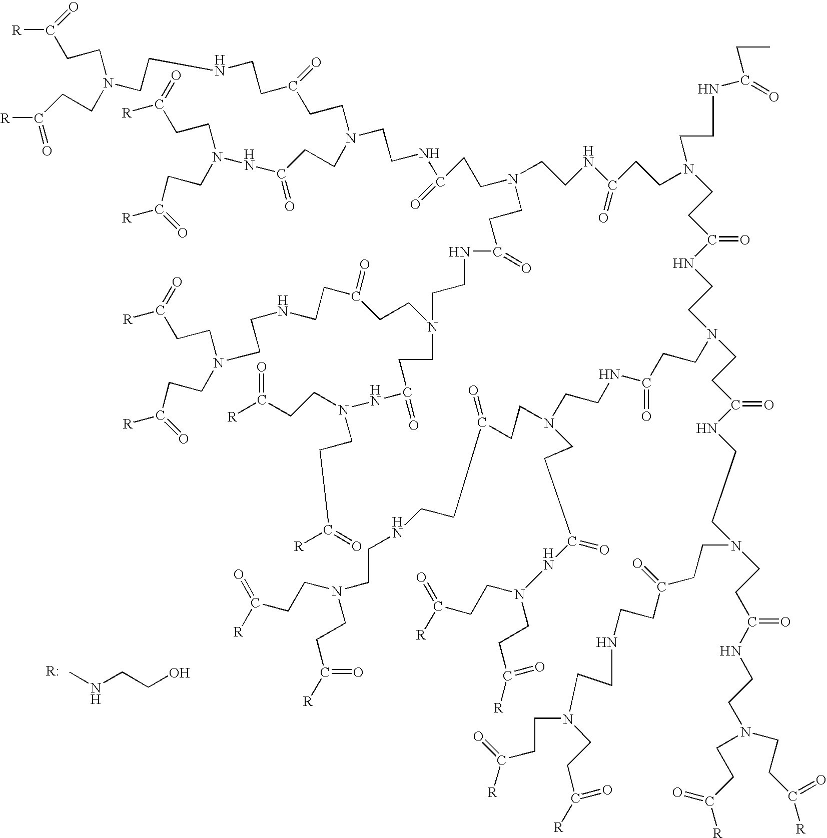

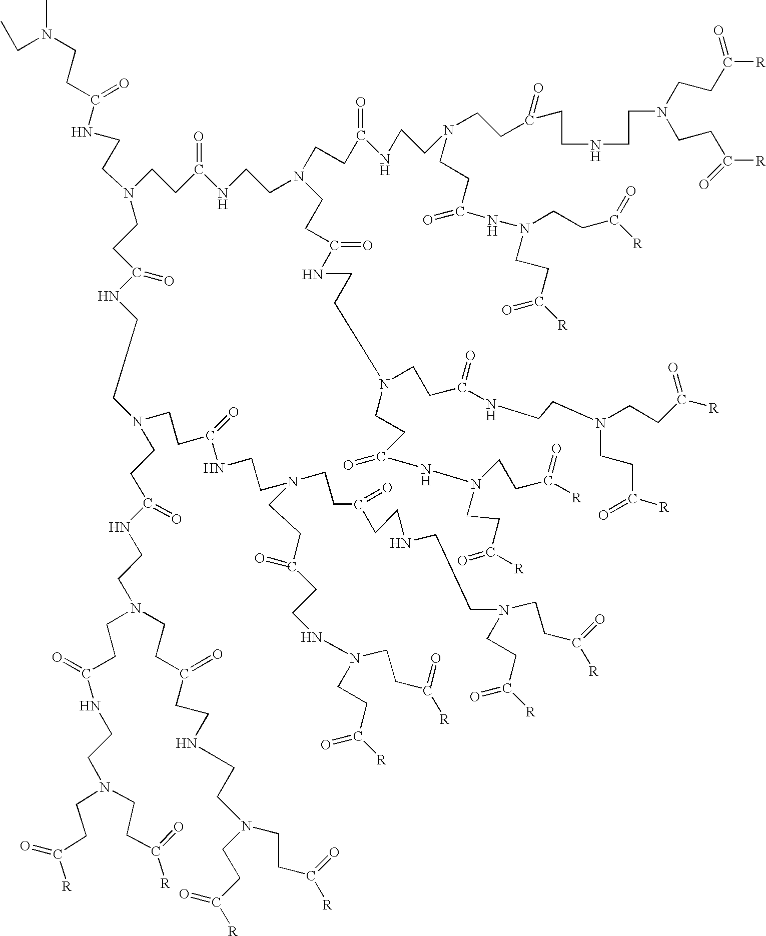

The dendrimer perfeerably has, on its surface, a functional group that undergoes substantially no interaction with metal ions. Such functional groups that do not interact with metal ions are preferably hydroxyl group (—OH group), benzyl group, methoxy group, and other groups having no hetero atom. Examples of such moieties are alcohols, carboxy esters, aromatic hydrocarbons, alkoxyls, and alkyls.

The functional group on the surface of the dendrimer can be converted into another functional group through an appropriate chemical reaction. For example, when the surface functional group is an amino group, the amino group can be converted into another functional group serving as the surface functional group by subjecting the amino group to a Michael reaction with a compound having the target functional group.

Examples of the dendron are not specifically limited, may be selected according to the purpose and include the dendrons (1) through (18) shown below.

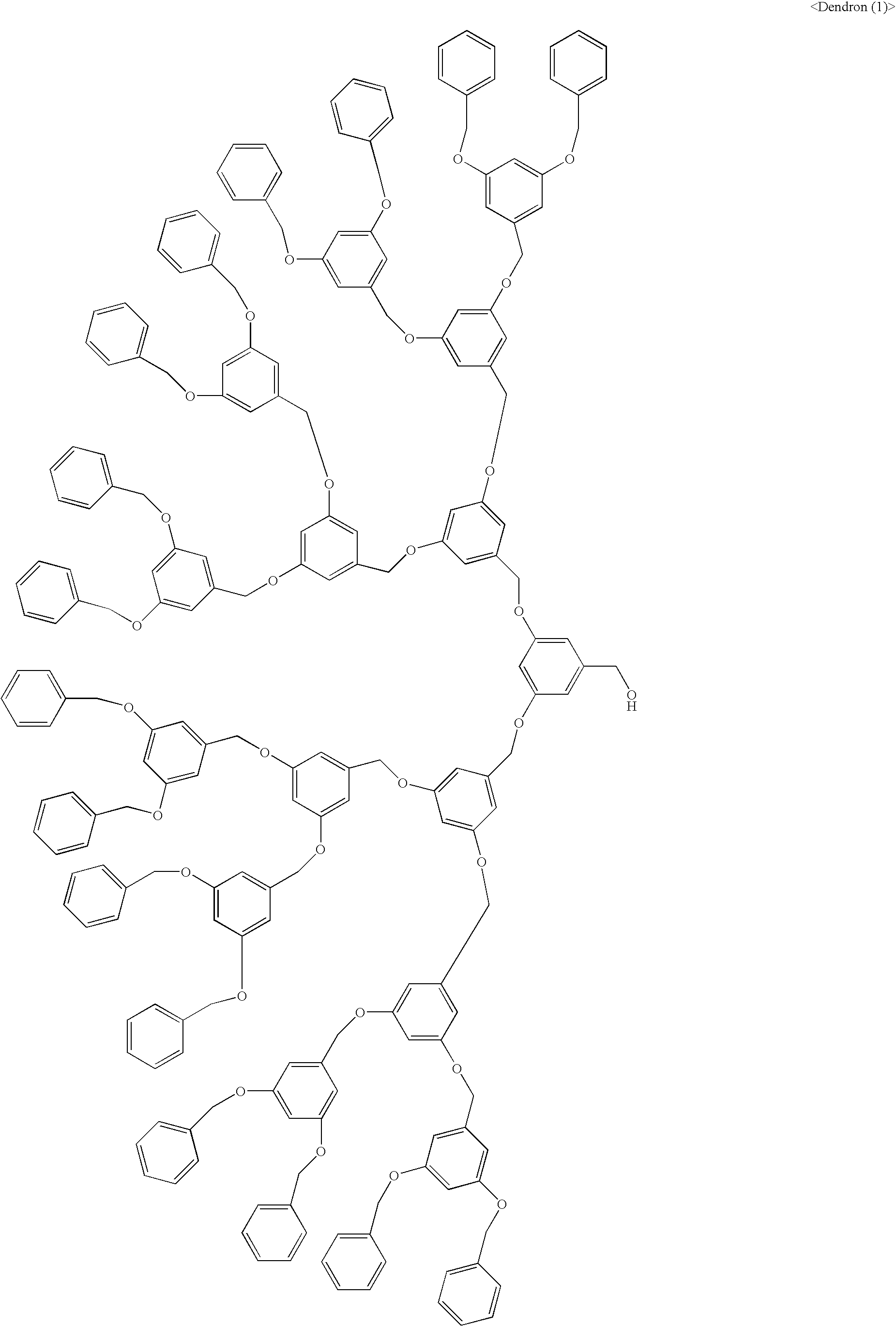

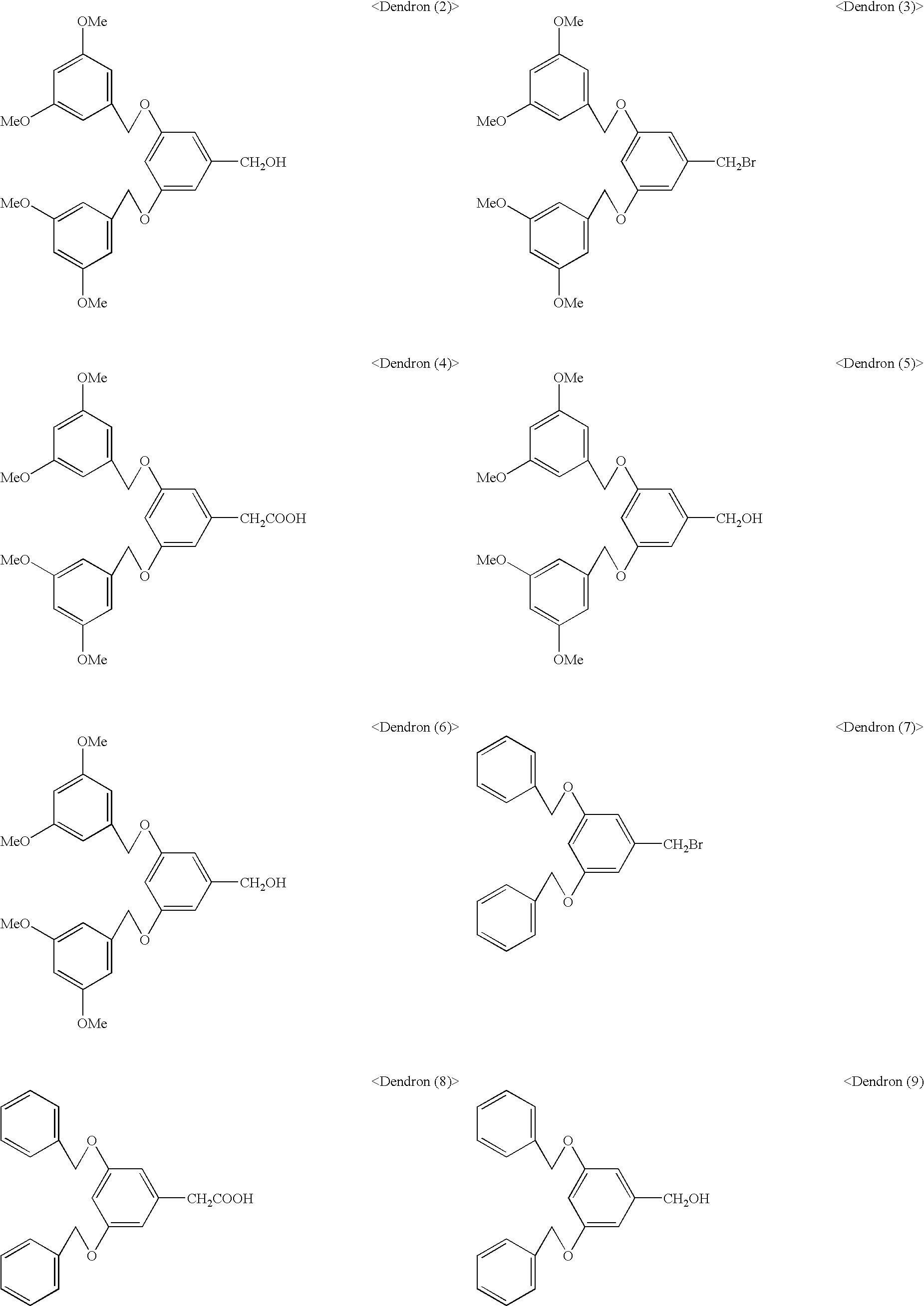

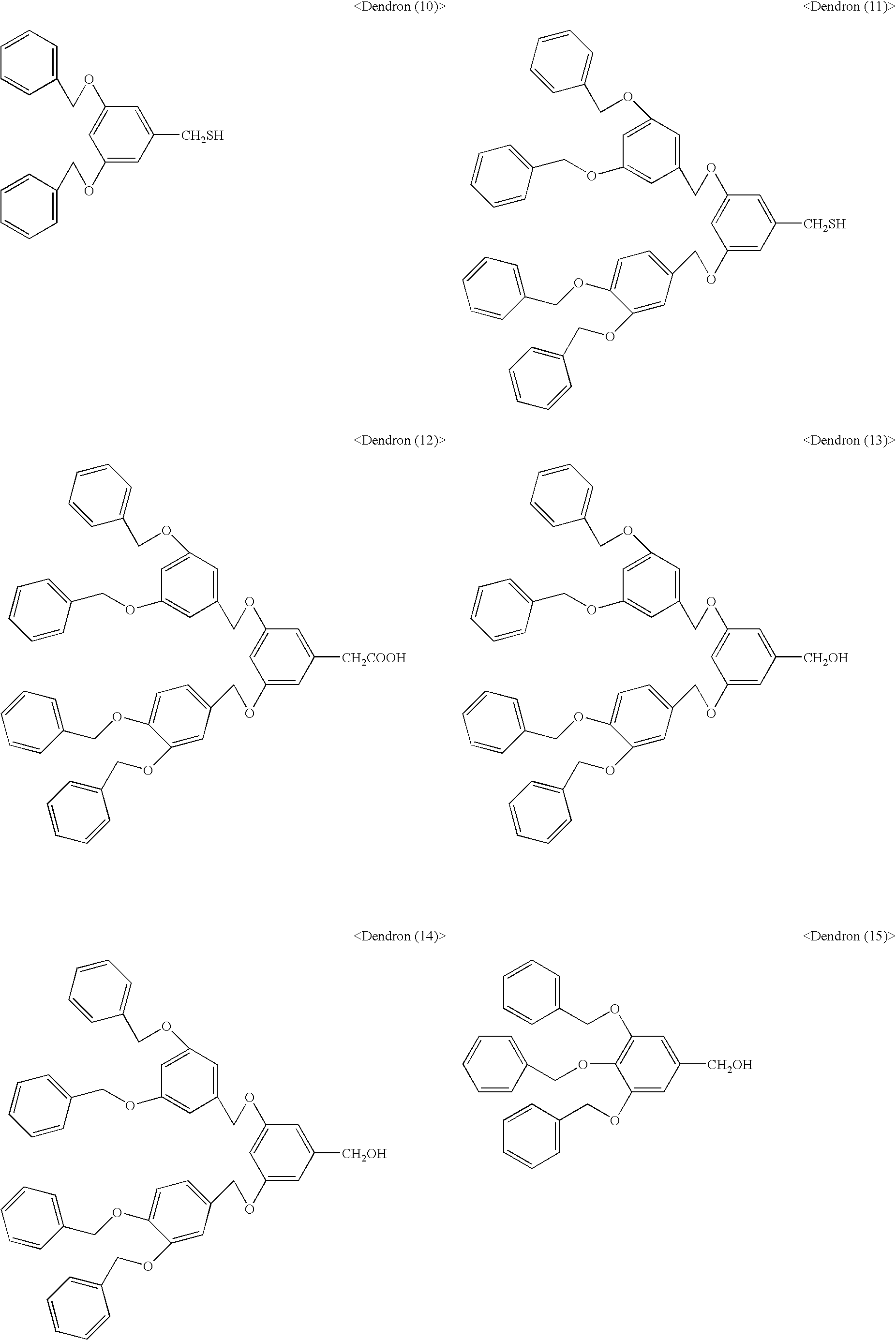

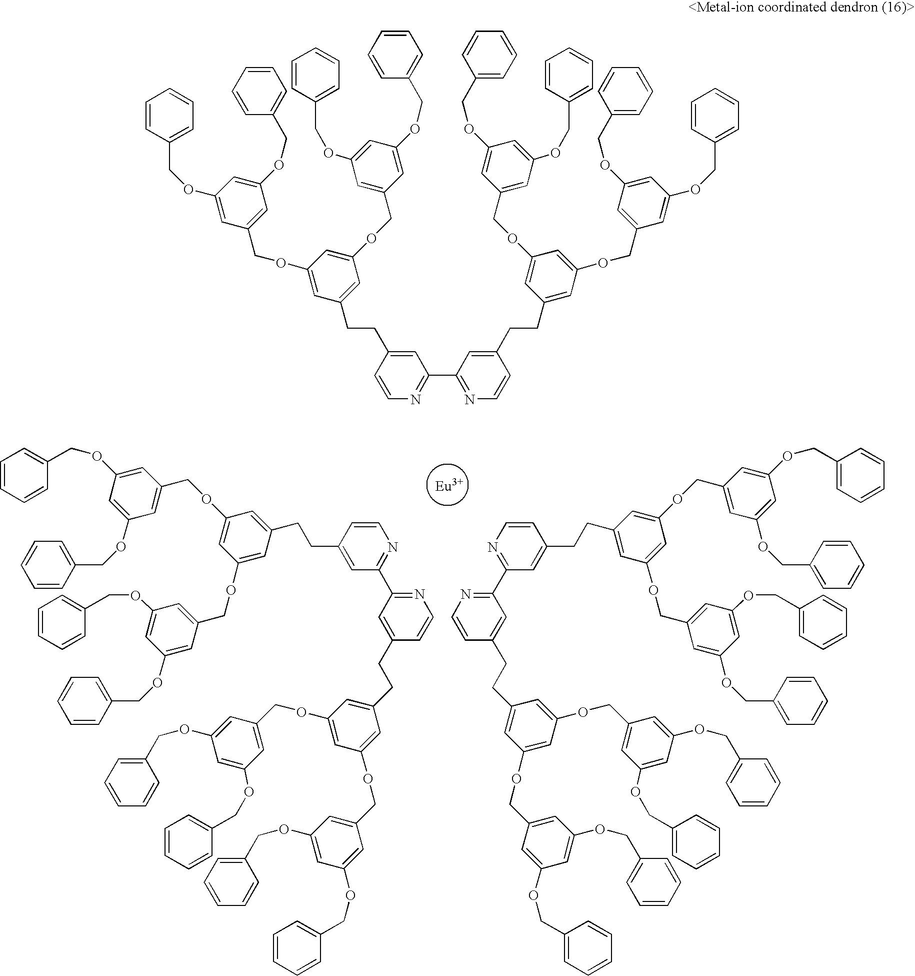

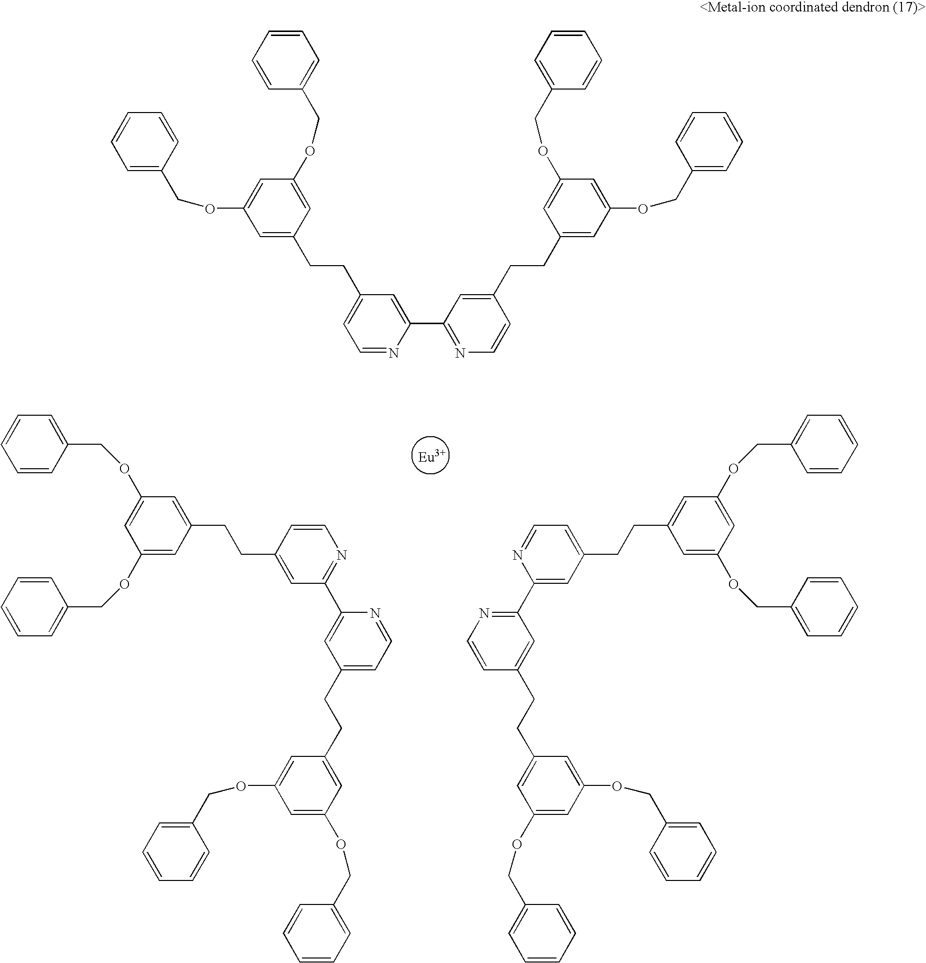

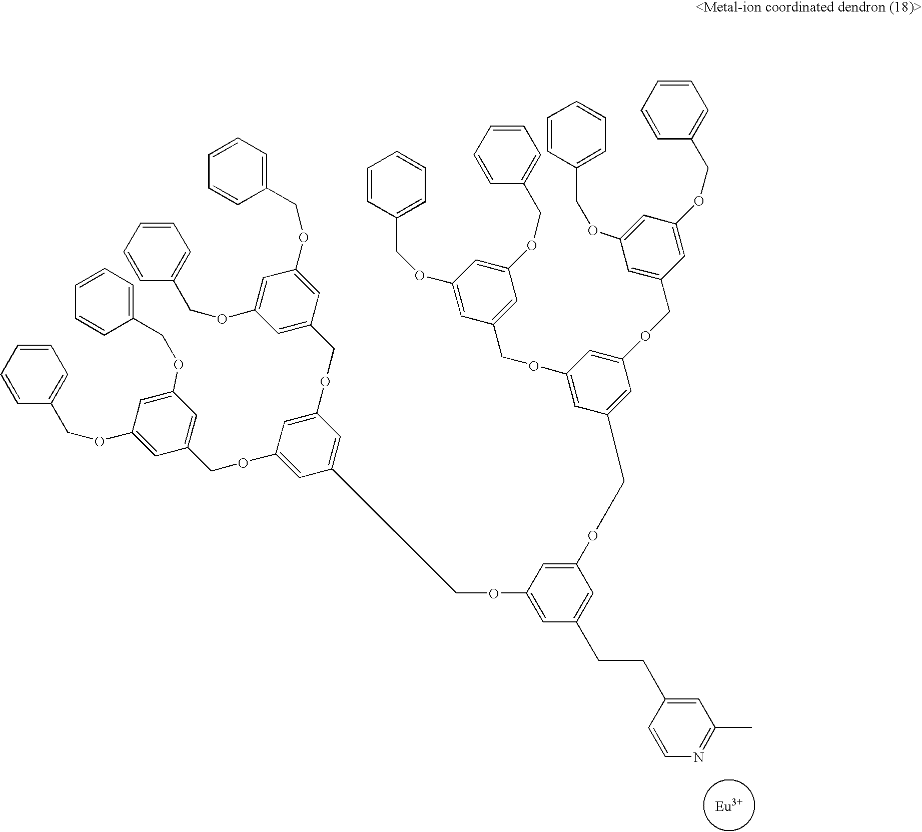

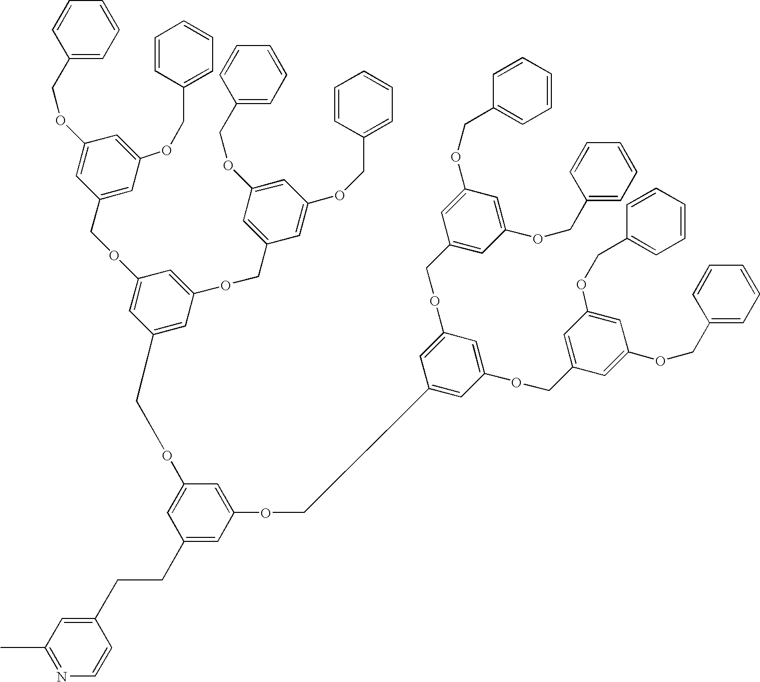

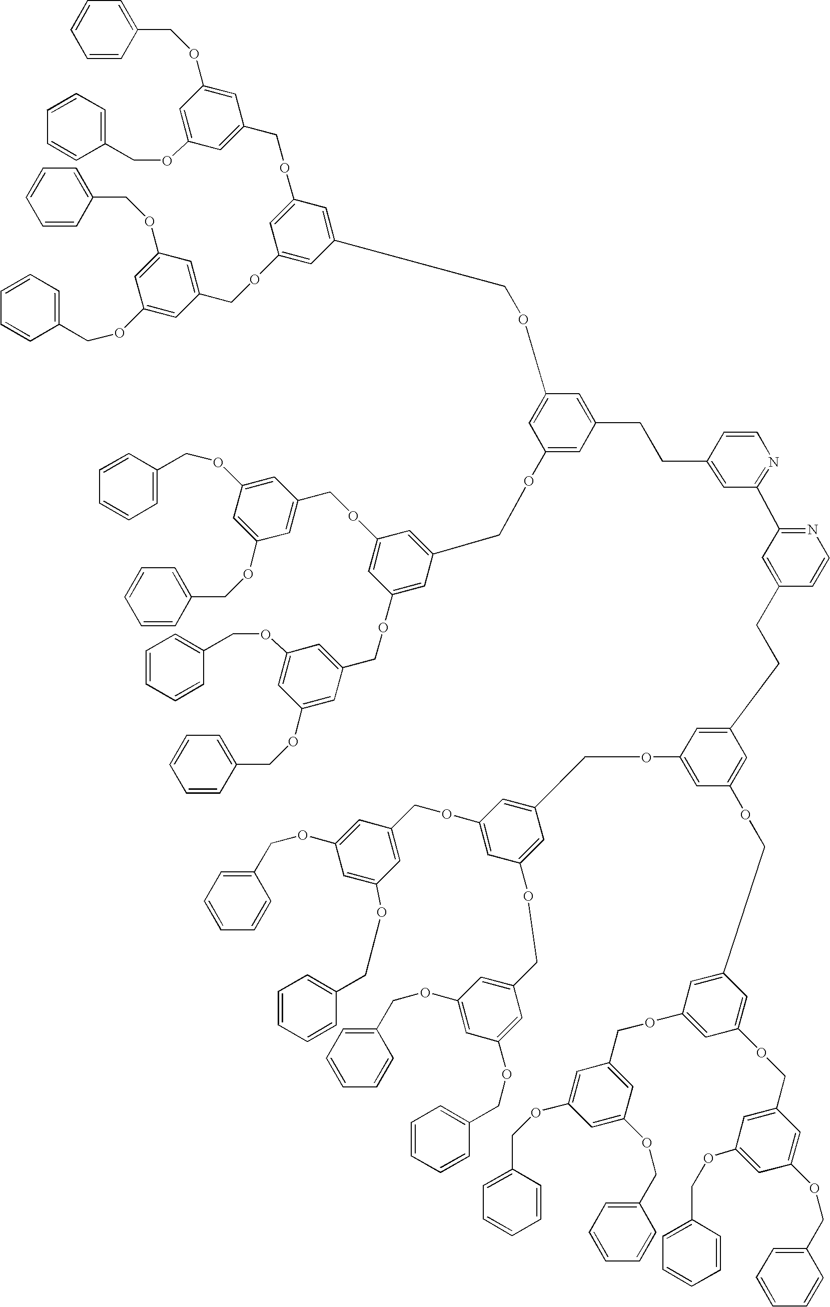

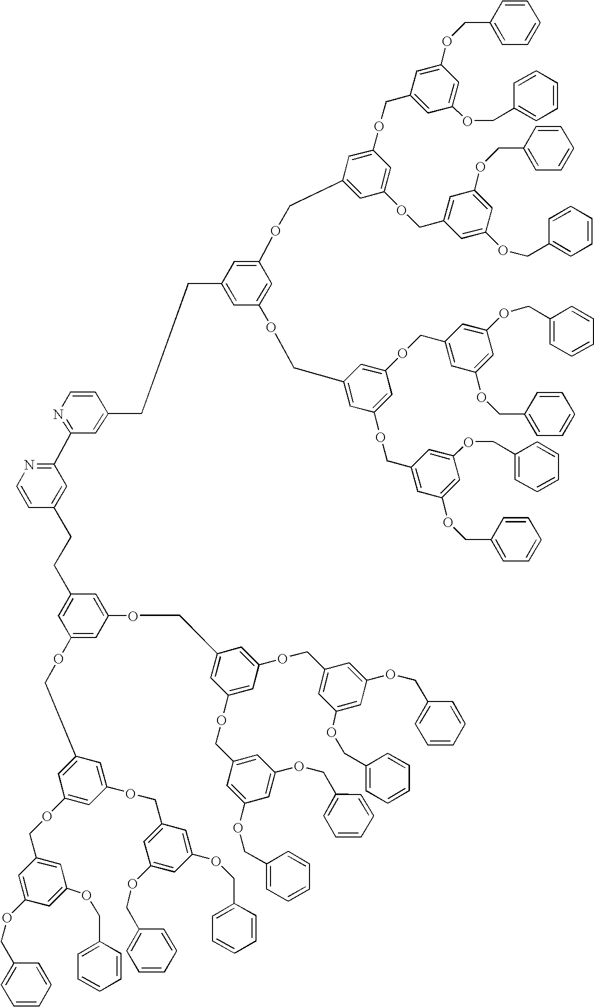

The dendron for use in the present invention is not specifically limited and may be selected according to the purpose. Commercially available products can also be used as the dendron.

A metal ion can be incorporated into the dendron by any method that is not specifically limited and may be selected according to the purpose. For example, a dendron bearing a metal ion can be prepared by mixing a dendron with a solution containing a target metal ion and subjecting the mixture to reduction.

Metallic Particles

The metallic particles are not specifically limited and may be selected according to the purpose, as long as they are at least metallic particles selected from metal particles and alloy particles. The number-average particle diameter (D₅₀) of the metallic particles is preferably 500 nm or less, more preferably 200 nm or less, and further preferably 80 nm or less.

The metal just mentioned above is not specifically limited, may be selected according to the purpose and can be any of elementary metals, metal chalcogenides, and metal halides. Examples of the metal are Ti, Fe, Co, Ni, Zr, Mo, Ru, Rh, Ag, Cd, Sn, Ir, Pt, Au, Pb, Bi, and alloys of these metals.

The alloys for use in the present invention are not specifically limited, may be selected according to necessity and include, for example, alloys between any of the aforementioned metals and one selected from Sc, Y, Ti, Zr, V, Nb, Fe, Co, Ni, Ru, Rh, Pd, Os, Ir, lanthanoid elements, and actinoid elements.

The content of the metallic particles, if any, in the dendritic branching molecule is preferably from 0.01% to 30% by mass, and more preferably from 0.05% to 5% by mass.

Metal Ions

The metal ions are not specifically limited and may be selected according to the purpose. Preferred metal ions are cations of elements belonging to Groups 1A (alkali metals), 2A (alkaline earth metals), 3A, 4A, 5A, 6A, 7A, 8, 1B, 2B (these are transition metals), 3B, 4B, and 5B of the Periodic Table of Elements, other than hydrogen, boron, carbon, nitrogen, and phosphorus.

Examples of the cations are Li⁺, Na⁺, K⁺, Rb⁺, Cs⁺, Fr⁺, and other alkali metal cations; Be²⁺, Mg²⁺, Ca²⁺, Sr²⁺, Ba²⁺, Ra²⁺, and other cations of alkaline earth metals; Sc³⁺, Y³⁺. and other cations of scandium group elements; Ti²⁺, Ti³⁺, Ti⁴⁺, Zr⁺, Zr²⁺, Zr³⁺, Zr⁴⁺, Hf⁺, Hf²⁺, Hf³⁺, Hf⁴⁺, and other cations of titanium group elements; V⁺, V²⁺, V³⁺, V⁴⁺, V⁵⁺, Nb⁺, Nb²⁺, Nb³⁺, Nb⁴⁺, Nb⁵⁺, Ta⁺, Ta²⁺, Ta³⁺, Ta⁴⁺, Ta⁵⁺, and other cations of vanadium group elements; Cr⁺, Cr²⁺, Cr³⁺, Cr⁴⁺, Cr⁵⁺, Cr⁶⁺, Mo⁺, Mo²⁺, Mo³⁺, Mo⁴⁺, Mo⁵⁺, Mo⁶⁺, W⁺, W²⁺, W³⁺, W⁴⁺, W⁵⁺, W⁶⁺, and other cations of chromium group elements; Mn⁺, Mn²⁺, Mn³⁺, Mn⁴⁺, Mn⁵⁺, Mn⁶⁺, Mn⁷⁺, Tc⁺, Tc²⁺, Tc³⁺, Tc⁴⁺, Tc⁵⁺, Tc⁶⁺, Tc⁷⁺, Re⁺, Re²⁺, Re³⁺, Re⁴⁺, Re⁵⁺, Re⁶⁺, Re⁷⁺, and other cations of manganese group elements; Fe⁺, Fe²⁺, Fe³⁺, Fe⁴⁺, Fe⁶⁺, Ru⁺, Ru²⁺, Ru³⁺, Ru⁴⁺, Ru⁵⁺, Ru⁶⁺, Ru⁷⁺, Ru⁸⁺, Os⁺, Os²⁺, Os³⁺, Os⁴⁺, Os⁵⁺, Os⁶⁺, Os⁷⁺, Os⁸⁺, and other cations of iron group elements; Co⁺, Co²⁺, Co³⁺, Co⁴⁺, Co⁵⁺, Rh⁺, Rh²⁺, Rh³⁺, Rh⁴⁺, Rh⁵⁺, Rh⁶⁺, Ir⁺, lr²⁺, Ir³⁺, Ir⁴⁺, Ir⁵⁺, Ir⁶⁺, and other cations of cobalt group elements; Ni⁺, Ni²⁺, Ni³⁺, Ni⁴⁺, Pd⁺, Pd²⁺, Pd³⁺, Pd⁴⁺, Pt²⁺, Pt³⁺, Pt⁴⁺, Pt⁵⁺, Pt⁶⁺, and other cations of nickel group elements; Cu⁺, Cu²⁺, Cu³⁺, Cu⁴⁺, Ag⁺, Ag²⁺, Ag³⁺, Au⁺, Au²⁺, Au³⁺, Au⁵⁺, Au⁷⁺, and other cations of copper group elements; Zn²⁺, Cd⁺, Cd²⁺, Hg⁺, Hg²⁺, and other cations of zinc group elements; La²⁺, La³⁺, Ce²⁺, Ce³⁺, Ce⁴⁺, Pr²⁺, Pr³⁺, Pr⁴⁺, Nd²⁺, Nd³⁺, Nd⁴⁺, Pm²⁺, Pm³⁺, Sm²⁺, Sm³⁺, Eu²⁺, Eu³⁺, Gd²⁺, Gd³⁺, Tb²⁺, Tb³⁺, Tb⁴⁺, Dy²⁺, Dy³⁺, Dy⁴⁺, Ho²⁺, Ho³⁺, Er²⁺, Er³⁺, Tm²⁺, Tm³⁺, Yb²⁺, Yb³⁺, Lu²⁺, Lu³⁺, and other cations of lanthanoids; Ac³⁺, Th⁴⁺, Pa³⁺, Pa⁴⁺, Pa⁵⁺, U³⁺, U⁴⁺, U⁵⁺, U⁶⁺, Np³⁺, Np⁴⁺, Np⁵⁺, Np⁶⁺, Pu³⁺, Pu⁴⁺, Pu⁵⁺, Pu⁶⁺, Am²⁺, Am³⁺, Am⁴⁺, Am⁵⁺, Am⁶⁺, Cm³⁺, Cm⁴⁺, Bk³⁺, Bk⁴⁺, Cf²⁺, Cf³⁺, Cf⁴⁺, Es²⁺, Es³⁺, Fm²⁺, Fm³⁺, Md²⁺, Md³⁺, No²⁺, No³⁺, and other cations of actinoids; Al³⁺, Ga²⁺, Ga³⁺, In⁺, In²⁺, In³⁺, Tl⁺, Tl²⁺, Tl³⁺, and other cations of Group 3B elements; Si²⁺, Si⁴⁺, Ge²⁺, Ge⁴⁺, Sn²⁺, Sn⁴⁺, Pb²⁺, Pb⁴⁺, and other cations of Group 4B elements; As³⁺, As⁵⁺, Sb⁺, Sb³⁺, Sb⁵⁺, Bi⁺, Bi³⁺, Bi⁵⁺, and other cations of Group 5B elements. Among them, catins of Ti, Fe, Co, Ni, Zr, Mo, Ru, Rh, Ag, Cd, Sn, Ir, Pt, Au, Pb, and Bi are preferred.

The dendritic branching molecule including the metallic particles can be produced by any method that is not specifically limited and may be selected according to the purpose. A preferred method is one in which a controlled and predetermined amount of one or more types of metal ions is incorporated and fixed into a dendritic branching molecule having S atoms, N atoms, and other structural moieties capable of coordinating with a metal ion, and the resulting substance is reduced. According to this method, the dendritic branching molecule including the metallic particles can be efficiently produced.

Examples of a reducing agent for use herein are sodium borohydride, hydrazine, and ascorbic acid.

The dendritic branching molecule including metal particles can also be efficiently produced by a method in which a constant and controlled amount of one or more types of metal ions are fixed into inside a dendritic branching molecule by electrostatic interaction, and the resulting substance is reduced. For example, the dendritic branching molecule including metal particles is produced by a method in which a tertiary amine is converted into a quaternary amine in the presence of hydrochloric acid, and the quaternary amine is allowed to electrostatically interact with a metal acid anion.

The dendritic branching molecule preferably has a structure capable of binding to the dye or metallic particles. In particular, when the coloring agent is one that develops a color by converting or incorporating into a metal ion, the dendritic branching molecule preferably has a terminal —COOH group, —SH group, —NH₂ group, —OH group, or another group that can coordinate with a metal ion.

When the coloring agent is a metal such as metal particles inclusive of semiconductive metal fine particles, the dendritic branching molecule preferably has terminal —SH group, —NH₂ group, or another group capable of directly combining with such metal particles. The dendritic branching molecule is preferably one capable of coordinating with a metal ion, since its refractive index changes due to coordination with a metal ion and it can impart a distinctive color or hue to the aqueous ink-jet ink.

The dendritic branching molecule preferably has a functional group capable of forming a covalent bond.

Among the aforementioned coloring agents, preferred are those which comprise a rare earth metal or semiconductive metal fine particles and are used as particles in combination with the dendritic branching molecule. Thus, the coloring agent can impart a distinctive hue to the aqueous ink-jet ink, is satisfactorily dispersed, is stably stored and has a uniform average particle diameter, and the amount of the coloring agent can be reduced.

Examples of the rare earth metal are lanthanoid elements, i.e., La, Ce, Pr, Nd, Pm, Sm, Eu, Gd, Th, Dy, Ho, Er, Tm, Yb, and Lu.

The semiconductive metal fine particle for use herein is not specifically limited, may be selected according to the purpose and includes, for example, fine particles of elementary semiconductors, oxide semiconductors, compound semiconductors, organic semiconductors, complex oxide semiconductors, and mixtures of these semiconductors. These semiconductors may contain impurities as dopants. The semiconductors can have any form such as a single crystal, polycrystal, amorphous, and mixtures of these forms.

The elementary semiconductors include, but are not limited to, silicon (Si), germanium (Ge), and tellurium (Te).

The oxide semiconductors are metal oxides having semiconductive properties and include, for example, TiO₂, SnO₂, Fe₂O₃, SrTiO₃, WO₃, ZnO, ZrO₂, Ta₂O₅, Nb₂O₅, V₂O₅, In₂O₃, CdO, MnO, CoO, TiSrO₃, KTiO₃, Cu₂O, sodium titanate, barium titanate, and potassium niobate.

The compound semiconductors include, but are not limited to, cadmium sulfide, zinc sulfide, lead sulfides, silver sulfides, antimony sulfides, bismuth sulfides, cadmium selenide, lead selenide, cadmium telluride, zinc phosphide, gallium phosphide, indium phosphide, cadmium phosphide, gallium arsenide selenide, copper indium selenide, and copper indium sulfide.

The organic semiconductors include, but are not limited to, polythiophenes, polypyrroles, polyacetylenes, poly(phenylene vinylene)s, and poly(phenylene sulfide)s.

The complex oxide semiconductors include, but are not limited to, SnO₂—ZnO, Nb₂O₅—SrTiO₃, Nb₂O₅—Ta₂O₅, Nb₂O₅—ZrO₂, Nb₂O₅—TiO₂, Ti—SnO₂, Zr—SnO₂, and Bi—SnO₂.

The dendritic branching molecule serving as the coloring agent is most preferably at least one selected from metal chelate compounds comprising a dendron capable of coordinating to a metal ion, and compounds comprising a dendron capable of binding to a semiconductive metallic fine particle.

The average particle diameter of the dendritic branching molecule including the metallic particles in terms of volume average particle diameter (D₅₀) is preferably from 1 nm to 100 μm, and more preferably from 1 nm to 10 nm. The resulting aqueous ink-jet ink has a distinctive hue, in which the coloring agent is satisfactorily dispersed, is stably stored and has a uniform average particle diameter.

The average particle diameter of the dendritic branching molecule including at least one of the dyes and metallic particles can be easily controlled to be uniform and small by molecular weight control. The inclusion efficiently suppress aggregation of particles of the coloring agent included in the dendritic branching molecule and appropriately controls permeation of substances to the surface of the coloring agent. By using the dendritic branching molecule including the coloring agent, the aqueous ink-jet ink according to the present invention can have a distinct hue and can be discharged smoothly, in which the coloring agent is satisfactorily dispersed and stably stored and has a uniform particle diameter.

The size of the metal constituting the coloring agent in terms of volume average particle diameter (D₅₀) is preferably less than 10 nm, and more preferably less than 5 nm.

The content of the dendritic branching molecule including at least one of the dyes and metallic particles as the coloring agent is preferably from 0.1% to 50% by mass, and more preferably from 0.5% to 10% by mass in the aqueous ink-jet ink. Thus, the resulting aqueous ink-jet ink has a distinctive hue, in which the coloring agent is satisfactorily dispersed, is stably stored and has a uniform particle diameter.

Examples of the dyes to be included in the dendritic branching molecule are known or conventional dyes for use in aqueous ink-jet inks.

Examples of such dyes include, but are not limited to, Color Index (C.I.) Direct Black-2, 4, 9, 11, 17, 19, 22, 32, 80, 151, 154, 168, 171 and 194, C.I. Direct Blue-1, 2, 6, 8, 22, 34, 70, 71, 76, 78, 86, 112, 142, 165, 199, 200, 201, 202, 203, 207, 218, 236 287 and 307, C.I. Direct Red-1, 2, 4, 8, 9, 11, 13, 15, 20, 28, 31, 33, 37, 39, 51, 59, 62, 63, 73, 75, 80, 81, 83, 87, 90, 94, 95, 99, 101, 110, 189, and 227, C.I. Direct Yellow-1, 2, 4, 8, 11, 12, 26, 27, 28, 33, 34, 41, 44, 48, 58, 86, 87, 88, 132, 135, 142 and 144, C.I. Food Black-1 and 2.

Examples of the dyes also include C.I. Acid Black-1, 2, 7, 16, 24, 26, 28, 31, 48, 52, 63, 107, 112, 118, 119, 121, 156, 172, 194 and 208, C.I. Acid Blue-1, 7, 9, 15, 22, 23, 27, 29, 40, 43, 55, 59, 62, 78, 80, 81, 83, 90, 102, 104, 111, 185, 249 and 254, C.I. Acid Red-1, 4, 8, 13, 14, 15, 18, 21, 26, 35, 37, 52, 110, 144, 180, 249 and 257, C.I. Acid Yellow-1, 3, 4, 7, 11, 12, 13, 14, 18, 19, 23, 25, 34, 38, 41, 42, 44, -53, 55, 61, 71, 76, -78, 79 and 122.

Each of these dyes can be used alone or in combination.

As the coloring agent, all the dyes mentioned in the “dendritic branching polymers including a dye and/or metallic particle”, and the following pigments can be advantageously used.

Examples of the pigments for use herein are magenta pigments such as C.I. Pigment Red-3, 5, 19, 22, 31, 38, 43, 48:1, 48:2, 48:3, 48:4, 48:5, 49:1, 53:1, 57:1, 57:2, 58:4, 63:1, 81, 81:1, 81:2, 81:3, 81:4, 88, 104, 108, 112, 122, 123, 144, 146, 149, 166, 168, 169, 170, 177, 178, 179, 184, 185, 208, 209, 216, 226, and 257, C.I. Pigment Violet-3, 19, 23, 29, 30, 37, 50, and 88; and C.I. Pigment Orange-13, 16, 20, and 36. Each of these pigments can be used alone or in combination.

Examples of cyan pigments are C.I. Pigment Blue-1, 15, 15:1, 15:2, 15:3, 15:4, 15:6, 16, 17-1, 22, 27, 28, 29, 36, and 60.

Examples of yellow pigments are C.I. Pigment Yellow-1, 3, 12, 13, 14, 17, 34, 35, 37, 55, 74, 81, 83, 93, 94, 95, 97, 108, 109, 110, 137, 138, 139, 153, 154, 155, 157, 166, 167, 168, 180, 185, and 193.

Examples of black pigments are C.I. Pigment Black-7, 28, and 26.

Each of these coloring agents can be used alone or in combination. The content of the coloring agent in the aqueous inkjet ink, except the content of the coloring agent included in the dendritic branching molecule, is preferably from 0.1% to 50% by mass, and more preferably from 0.5% to 10% by mass, for good hue of the aqueous ink-jet ink.

The hydrophilic solvents are used so as to suppress evaporation of water contained in the aqueous ink-jet ink and to improve moisture retention, discharge stability, and image quality when printed on plain paper. The hydrophilic solvents include, but are not limited to, methanol, ethanol, propanol, isobutyl alcohol, sec-butyl alcohol, t-butyl alcohol, pentanol, hexanol, cyclohexanol, benzyl alcohol, and other alcohols; ethylene glycol, diethylene glycol, propylene glycol, polyethylene glycol, triethylene glycol, glycerol, trimethylolpropane, 1,2,6-hexanetriol, 1,5-pentanediol, dipropylene glycol, and other polyhydric alcohols; methylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monomethyl ether, propylene glycol monobutyl ether, and other glycol ethers; thiodiethanols, 2-mercaptoethanol, thioglycerol, sulfolane, dimethyl sulfoxide, and other sulfur-containing solvents; 2-pyrrolidone, N-methyl-2-pyrrolidone, cyclohexylpyrrolidone, triethanolamine, diethanolamine, and other nitrogen-containing solvents. To avoid clogging of nozzles, sulfur-containing solvents and nitrogen-containing solvents are preferred. Each of these hydrophilic solvents can be used alone or in combination.

The content of the hydrophilic solvent is preferably from 1% to 90% by mass of the total mass of the aqueous ink-jet ink.

The surfactant is used to serve as a penetrant for shortening a drying time of recorded images and for improving penetration of the aqueous ink-jet ink to a recording material, as a stabilizer for stabilizing dissolution and dispersion of the coloring agent such a dye or a pigment, and as a wiper cleaning agent for cleaning an ink-jet head in an ink-jet recording apparatus.

The surfactant can be any of surfactants generally used in aqueous or water-based ink-jet inks and includes nonionic surfactants, anionic surfactants, and amphoteric surfactants.

The nonionic surfactants include, but are not limited to, polyoxyethylene alkyl phenyl ethers, polyoxyethylene alkyl ethers, polyoxyethylene fatty acid esters, sorbitan fatty acid esters, polyoxyethylene sorbitan fatty acid esters, polyoxyethylene glycerol fatty acid esters, polyglycerol fatty acid esters, polyoxyethylene polyoxypropylene ethers, polyoxyethylene sorbitol fatty acid esters, polyoxyethylene sterols, polyoxyethylene fatty acid amides, polyoxyethylene polyoxypropylene block copolymers, tetramethyldecynediol, and tetramethyldecynediol ethylene oxide adducts.

The anionic surfactants include, but are not limited to, alkylnaphthalenesulfonates, alkylbenzenesulfonates, higher fatty acid salts, sulfates of higher fatty acid esters, sulfonates of higher fatty acid esters, sulfates of higher alcohol ethers, sulfonates of higher alcohol ethers, higher alkylsulfosuccinates, formaldehyde condensates of phanthalenesulfonates, polystyrenesulfonates, polyacrylates, polyoxyethyleenn alkyl ether phosphates, alkyl ether carboxylates, alkylsulfates, and acrylic acid-acrylic ester copolymers.

The amphoteric surfactants include, but are not limited to, betaines, sulfobetaines, sulfate betaines, and imidazoline.

Each of these surfactants can be used alone or in combination. Among them, nonionic surfactants are preferred so that formed images are more uniform, can be dried satisfactorily, and foaming and clogging of the ink can be suppressed.

Ink Cartridge

The ink cartridge of the present invention comprises a case and the aqueous ink-jet ink of the present invention contained in the case. The ink cartridge may further comprise other members selected according to necessity.

The case can have any shape, structure, size, and material selected according to the purpose. A preferred example of the case is one having at least an ink bag made of, for example, an aluminum-laminated film or a resin film.

The present invention will be illustrated in further detail with reference to several examples and comparative examples below, but it will be understood that the present invention is not to be construed as being limited to these examples.

### PREPARATION EXAMPLE 1

### Synthesis of Dendrimer (1)

(1) Synthesis of 1,4-diaminobutane-N,N′-tetra-1-acrylonitrile: DAB(ACN)₄

In a 2-liter three-neck flask equipped with a stirrer, a condenser tube, and a dropping funnel were placed 88 g (1 mol) of 1,4-diaminobutane (DAB) and 1200 ml of water. To the stirred mixture was added dropwise 424 g (8 mol) of acrylonitrile, and after the completion of addition, the mixture was heated with stirring under reflux at 80° C. for 1 hour.

Water and excess acrylonitrile were removed by distillation under reduced pressure and thereby yielded 290 g of 1,4-diaminobutane-N,N′-tetra-1-acrylonitrile (DAB(ACN)₄). The resulting compound was structurally identified by ¹³C-NMR.

(2) Synthesis of Dendrimer (1) G1: 1,4-diaminobutane-N,N′-tetra-1-propylamine: DAB(PA)₄

In a 1-liter autoclave were placed 24 g (0.08 mol) of DAB(ACN)₄ and 200 ml of methanol, and 5.6 g of a Raney cobalt catalyst (Co: 78-96% by mass, Cr: 0.5-5% by mass, Ni: 0.5-5% by mass, Al: 3-12% by mass) which had been washed with 25 ml of ethanol was further placed in the autoclave. The autoclave was closed, the inside atmosphere thereof was placed with hydrogen gas two times, and hydrogen gas was supplied to the autoclave to 50 atm. The mixture inside was heated to 60° C. with stirring.

The mixture was held with stirring at 60° C. for 20 minutes and was left stand to cool to room temperature. After replacing the inside atmosphere of the autoclave with nitrogen gas, the mixture was taken out, the Raney cobalt catalyst was removed by filtration, methanol was removed by distillation under reduced pressure and thereby yielded 24 g of 1,4-diaminobutane-N,N′-tetra-1-propylamine (DAB(PA)₄). The resulting compound was structurally identified by ¹³C-NMR.

(3) Synthesis of DAB(PA)₄(ACN)₈

In a 2-liter three-neck flask equipped with a stirrer and a condenser tube were placed 63 g (0.2 mol) of DAB(PA)₄ and 265 g (5 mol) of acrylonitrile, and the mixture was heated with stirring under reflux at 80° C. for 3 hours.

Excess acrylonitrile was removed by distillation under reduced pressure and thereby yielded 140 g of DAB(PA)₄(ACN)₈. The resulting compound was structurally identified by ¹³C-NMR.

(4) Synthesis of Dendrimer (1) G2: DAB(PA)₄(PA)₈

In a 2-liter autoclave were placed 59 g (0.08 mol) of DAB(PA)₄(ACN)₈ and 300 ml of methanol. In addition, 2.5 g of a Raney cobalt catalyst which had been washed with 25 ml of ethanol was placed in the autoclave, and the autoclave was closed. The inside atmosphere thereof was placed with hydrogen gas two times, and hydrogen gas was supplied to the autoclave to 50 atm. The mixture inside was heated to 50° C. with stirring. The mixture was held with stirring at 50° C. for 200 minutes and was left stand to cool to room temperature. After replacing the inside atmosphere of the autoclave with nitrogen gas, the mixture was taken out, the Raney cobalt catalyst was removed by filtration, methanol was removed by distillation under reduced pressure and thereby yielded 59 g of DAB(PA)₄(PA)₈. The resulting compound was structurally identified by ¹³C-NMR.

(5) Synthesis of DAB(PA)₄(PA)₈(ACN)₁₆

In a 2-liter three-neck flask equipped with a stirrer and a condenser tube were placed 39 g (0.05 mol) of DAB(PA)₄(PA)₈ and 212 g (4 mol) of acrylonitrile, and the mixture was heated with stirring under reflux at 80° C. for 4 hours.

Excess acrylonitrile was then removed by distillation under reduced pressure and thereby yielded DAB(PA)₄(PA)₈(ACN)₁₆. The resulting compound was structurally identified by ¹³C-NMR.

(6) Synthesis of Dendrimer (1) G3: DAB(PA)₄(PA)₈(PA)₁₆

In a 2-liter autoclave were placed 65 g (0.04 mol) of DAB(PA)₄(PA)₈(ACN)₁₆ and 300 ml of methanol. In addition, 6.0 g of a Raney cobalt catalyst which had been washed with 25 ml of ethanol was placed in the autoclave, and the autoclave was closed. The inside atmosphere thereof was placed with hydrogen gas two times, and hydrogen gas was supplied to the autoclave to 50 atm. The mixture inside was heated to 80° C. with stirring. The mixture was held with stirring at 80° C. for 240 minutes and was left stand to cool to room temperature. After replacing the inside atmosphere of the autoclave with nitrogen gas, the mixture was taken out, the Raney cobalt catalyst was removed by filtration, methanol was removed by distillation under reduced pressure and thereby yielded 64 g of DAB(PA)₄(PA)₈(PA)₁₆. The resulting compound was structurally identified by ¹³C-NMR.

(7) Synthesis of DAB(PA)₄(PA)₈(PA)₁₆(ACN)₃₂

In a 2-liter three-neck flask equipped with a stirrer and a condenser tube were placed 50.5 g (0.03 mol) of DAB(PA)₄(PA)₈(PA)₁₆ and 212 g (4 mol) of acrylonitrile, and the mixture was heated with stirring under reflux at 80° C. for 5 hours.

Excess acrylonitrile was then removed by distillation under reduced pressure and thereby yielded DAB(PA)₄(PA)₈(PA)₁₆(ACN)₃₂. The resulting compound was structurally identified by l³C-NMR.

(8) Synthesis of Dendrimer (1) G4: DAB(PA)₄(PA)₈(PA)₁₆(PA)₃₂

In a 2-liter autoclave were placed 67.6 g (0.02 mol) of DAB(PA)₄(PA)₈(PA)₁₆(ACN)₃₂ and 500 ml of methanol. In addition, 8.0 g of a Raney cobalt catalyst which had been washed with 25 ml of ethanol was placed in the autoclave, and the autoclave was closed. The inside atmosphere thereof was placed with hydrogen gas two times, and hydrogen gas was supplied to the autoclave to 50 atm. The mixture inside was heated to 80° C. with stirring. The mixture was held with stirring at 80° C. for 360 minutes and was left stand to cool to room temperature. After replacing the inside atmosphere of the autoclave with nitrogen gas, the mixture was taken out, the Raney cobalt catalyst was removed by filtration, methanol was removed by distillation under reduced pressure and thereby yielded 65 g of polypropylamine dendrimer (1): DAB(PA)₄(PA)₈(PA)₁₆(PA)₃₂. The resulting compound was structurally identified by ¹³C-NMR.

(9) Synthesis of Dendrimer (1): DAB(PA)₄(PA)₈(PA)₁₆(PA)₃₂(MSE)₆₄

In a 3-liter flask were placed 70 g (0.02 mol) of DAB(PA)₄(PA)₈(PA)₁₆(PA)₃₂, 500 ml of methanol, and then 1770 ml (1.28 mol) of a 10% by mass methanol solution of methyl vinyl sulfone. The mixture was held with stirring at room temperature in an atmosphere of nitrogen gas for 360 minutes, methanol was removed by distillation under reduced pressure and thereby yielded 247 g of (methylsulfonylethyl)polypropylamine dendrimer (1): DAB(PA)₄(PA)₈(PA)₁₆(PA)₃₂(MSE)₆₄. The resulting compound was structurally identified by ¹³C-NMR.

### EXAMPLE 1

Preparation of Aqueous Ink-Jet Ink

Magenta, cyan, and yellow aqueous ink-jet inks having the following compositions were prepared according to a conventional procedure.

| | |
|---|---|
| Composition of magenta aqueous ink-jet ink | |
| Dendrimer of Preparation Example 1 | 5% by mass |
| Magenta pigment | 10% by mass |
| Glycerol | 10% by mass |
| Diethanolamine | 5% by mass |
| Polyoxyethylene polyoxypropylene ether | 5% by mass |
| Ion-exchanged water | Balance |
| Composition of cyan aqueous ink-jet ink | |
| Dendrimer of Preparation Example 1 | 5% by mass |
| Cyan pigment | 8% by mass |
| Glycerol | 10% by mass |
| Diethanolamine | 5% by mass |
| Polyoxyethylene polyoxypropylene ether | 5% by mass |
| Ion-exchanged water | balance |
| Composition of yellow aqueous ink-jet ink | |
| Dendrimer of Preparation Example 1 | 5% by mass |
| Yellow pigment | 12% by mass |
| Glycerol | 10% by mass |
| Diethanolamine | 5% by mass |
| Polyoxyethylene polyoxypropylene ether | 5% by mass |
| Ion-exchanged water | Balance |

### EXAMPLE 2

Preparation of Aqueous Ink-Jet Ink

Magenta, cyan, and yellow aqueous ink-jet inks having the following compositions were prepared according to a conventional procedure.

| | |
|---|---|
| Composition of magenta aqueous ink-jet ink | |
| Dendrimer of Preparation Example 1 | 10% by mass |
| Magenta pigment | 10% by mass |
| Glycerol | 10% by mass |
| Diethanolamine | 5% by mass |
| Polyoxyethylene polyoxypropylene ether | 5% by mass |
| Ion-exchanged water | Balance |
| Composition of cyan aqueous ink-jet ink | |
| Dendrimer of Preparation Example 1 | 10% by mass |
| Cyan pigment | 8% by mass |
| Glycerol | 10% by mass |
| Diethanolamine | 5% by mass |
| Polyoxyethylene polyoxypropylene ether | 5% by mass |
| Ion-exchanged water | balance |
| Composition of yellow aqueous ink-jet ink | |
| Dendrimer of Preparation Example 1 | 10% by mass |
| Yellow pigment | 12% by mass |
| Glycerol | 10% by mass |
| Diethanolamine | 5% by mass |
| Polyoxyethylene polyoxypropylene ether | 5% by mass |
| Ion-exchanged water | Balance |

### COMPARATIVE EXAMPLE 1

Magenta, cyan, and yellow aqueous ink-jet inks were prepared by the procedure of Example 1, except that the dendrimer of Preparation Example 1 was not used.

### COMPARATIVE EXAMPLE 2

Preparation of Aqueous Ink-Jet Ink

Magenta, cyan, and yellow aqueous ink-jet inks having the following compositions were prepared according to a conventional procedure.

| | |
|---|---|
| Composition of magenta aqueous ink-jet ink | |
| Dendrimer of Preparation Example 1 | 0.1% by mass |
| Magenta pigment | 10% by mass |
| Glycerol | 10% by mass |
| Diethanolamine | 5% by mass |
| Polyoxyethylene polyoxypropylene ether | 5% by mass |
| Ion-exchanged water | Balance |
| Composition of cyan aqueous ink-jet ink | |
| Dendrimer of Preparation Example 1 | 0.1% by mass |
| Cyan pigment | 8% by mass |
| Glycerol | 10% by mass |
| Diethanolamine | 5% by mass |
| Polyoxyethylene polyoxypropylene ether | 5% by mass |
| Ion-exchanged water | balance |
| Composition of yellow aqueous ink-jet ink | |
| Dendrimer of Preparation Example 1 | 0.1% by mass |
| Yellow pigment | 12% by mass |
| Glycerol | 10% by mass |
| Diethanolamine | 5% by mass |
| Polyoxyethylene polyoxypropylene ether | 5% by mass |
| Ion-exchanged water | Balance |

Evaluation

The dispersibility and storage stability, bleeding, and discharge stability were evaluated by the following methods for the color aqueous ink-jet inks according to Examples 1 and 2, and

### Comparative Examples 1 and 2

Dispersibility and Storage Stability of the Coloring Agent

Each of the color aqueous ink-jet inks was observed with a microscope to evaluate the dispersibility of the coloring agent. As a result, the inks of Examples 1 and 2 had satisfactory dispersibility. The inks were then left stand at room temperature for three months and were observed and evaluated in the same manner as above. The inks of Examples 1 and 2 exhibited satisfactory dispersibility even after storage.

In contrast, before storage, the inks of Comparative Examples 1 and 2, in which some aggregation of the pigment was observed, showed somewhat lower dispersibility than the inks of Examples 1 and 2. After storage at room temperature for three months, the inks of Comparative Examples 1 and 2, in which some aggregation and deposition of the pigment was observed, showed somewhat lower dispersibility than the inks of Examples 1 and 2.

Bleeding

A color image was printed on an ink-jet paper Super Photo Grade (photopaper, available from Fuji Photo Film Co., Ltd.) using each of the color aqueous ink-jet inks and an ink-jet printer PM-700C (trade name, available from Seiko Epson Corporation). The paper bearing the image was immersed in pure water, was dried by leaving room temperature, and whether or not the image showed bleeding was determined.

The inks of Examples 1 and 2 showed no bleeding in the images. In contrast, the inks of Comparative Examples 1 and 2 showed bleeding in the images.

Discharge Stability

Each of the inks of Examples 1 and 2 was charged into an ink cartridge and was left stand at room temperature for three months. Even after this procedure, the inks did not invite clogging of a head and could be smoothly discharged.

In contrast, the inks of Comparative Examples 1 and 2 invited clogging of a head after three-months storage in an ink cartridge at room temperature.

According to the present invention, water-soluble ink-jet inks are obtained which can be highly dispersed into organic and inorganic matrices, comprise a coloring agent capable of being satisfactorily dispersed, being stably stored and can be discharged smoothly, do not invite clogging of discharge heads even after the inks are not used for a long time, and can form images without bleeding.

What is claimed is:

1. An aqueous ink-jet ink comprising:
a solvent selected from water, hydrophilic solvents, and mixtures thereof;
a binder;
a coloring agent; and
a surfactant,
wherein the binder contains a dendritic branching molecule, and a content of the dendritic branching molecule is 0.5% by mass or more relative to a total mass of the aqueous ink-jet ink.

2. An aqueous ink-jet ink according to claim 1, wherein a content of the binder is from 0.5 % by mass to 20% by mass relative to the total mass of the aqueous ink-jet ink.

3. An aqueous ink-jet ink according to claim 1, wherein the dendritic branching molecule is one of a dendritic branching polymer and a dendron.

4. An aqueous ink-jet ink according to claim 3, wherein the dendritic branching polymer is one of a dendrimer and a hyperbranched polymer.

5. An aqueous ink-jet ink according to claim 1, wherein the coloring agent is a dendritic branching molecule including at least one of metal ions, metal particles, alloy particles, and dyes.

6. An aqueous ink-jet ink according to claim 5, wherein the dendritic branching molecule is at least one selected from metal chelate compounds comprising a dendron capable of coordinating to a metal ion, and compounds comprising a dendron capable of binding to a semiconductive metallic fine particle.

7. An aqueous ink-jet ink according to claim 5, wherein the metal ion is a rare earth metal ion.

8. An aqueous ink-jet ink according to claim 7, wherein the rare earth metal is at least one element selected from La, Ce, Pr, Nd, Pm, Sm, Eu, Gd, Tb, Dy, Ho, Er, Tm, Yb, and Lu.

9. An aqueous ink-jet ink according to claim 6, wherein the semiconductive metal fine particle is one of elemental semiconductors, oxide semiconductors, compound semiconductors, organic semiconductors, complex oxide semiconductors, and mixtures thereof.

10. An aqueous ink-jet ink according to claim 5, wherein the dendritic branching molecule is one of a dendritic branching polymer and a dendron.

11. An aqueous ink-jet ink according to claim 10, wherein the dendritic branching polymer is one of a dendrimer and a hyperbranched polymer.

12. An aqueous ink-jet ink according to claim 11, wherein the dendrimer has, on a surface thereof, a functional group that undergoes substantially no interaction with a metal ion.

13. An aqueous ink-jet ink comprising:
a solvent selected from water, hydrophilic solvents, and mixtures thereof;
a binder;
a coloring agent; and
a surfactant,
wherein the coloring agent contains a dendritic branching molecule including at least one of metal ions, metal particles, alloy particles, and dyes.

14. An aqueous ink-jet ink according to claim 13, wherein the dendritic branching molecule is at least one selected from metal chelate compounds comprising a dendron capable of coordinating to a metal ion, and compounds comprising a dendron capable of binding to a semiconductive metallic fine particle.

15. An aqueous ink-jet ink according to claim 13, wherein the metal ion is a rare earth metal ion.

16. An aqueous ink-jet ink according to claim 15, wherein the rare earth metal is at least one element selected from La, Ce, Pr, Nd, Pm, Sm, Eu, Gd, Tb, Dy, Ho, Er, Tm, Yb, and Lu.

17. An aqueous ink-jet ink according to claim 14, wherein the semiconductive metal fine particle is one of elemental semiconductors, oxide semiconductors, compound semiconductors, organic semiconductors, complex oxide semiconductors, and mixtures thereof.

18. An aqueous ink-jet ink according to claim 13, wherein the dendritic branching molecule is one of a dendritic branching polymer and a dendron.

19. An aqueous ink-jet ink according to claim 18, wherein the dendritic branching polymer is one of a dendrimer and a hyperbranched polymer.

20. An aqueous ink-jet ink according to claim 19, wherein the dendrimer has, on a surface thereof, a functional group that undergoes substantially no interaction with a metal ion.

21. An ink cartridge comprising:
a case; and
an aqueous ink-jet ink housed in the case,
wherein the aqueous ink-jet ink comprises,
a solvent selected from water, hydrophilic solvents, and mixtures thereof;
a dendritic branching molecule serving as a binder in a content of 0.5% by mass or more relative to a total mass of the aqueous ink-jet ink;
a coloring agent; and
a surfactant.
